(19) United States
(12) Patent Application Publication
(10) Pub. No.: US 2026/0353271 A1
(43) Pub. Date: Nov. 5, 2026

(54) A METHOD AND AN APPARATUS FOR RRC IDLE AND INACTIVE MODE IN A COMMUNICATION SYSTEM

(71) Applicant: Samsung Electronics Co., Ltd., Suwon-si, Gyeonggi-do (KR)

(72) Inventors: Jonas SEDIN, Staines (GB); Milos TESANOVIC, Staines (GB)

(21) Appl. No.: 19/151,534

(22) PCT Filed: Jan. 31, 2024
(86) PCT No.: PCT/KR2024/001471

§ 371 Date: Jul. 28, 2025

(30) Foreign Application Priority Data
Feb. 1, 2023 (GB) 2301475.6
Mar. 23, 2023 (GB) 2304274.0
Dec. 22, 2023 (GB) 2319975.5

(51) Int. Cl. H04W 48/20; H04W 40/22; H04W 76/27; H04W 84/04

(52) U.S. Cl. CPC H04W 48/20; H04W 40/22; H04W 76/27; H04W 84/047

(57) ABSTRACT

The disclosure relates to a 5G or 6G communication system for supporting a higher data transmission rate. According to various examples, there is provided a method of a repeater node for reporting presence, the method comprising: when camping on a first cell of a network, performing cell reselection to select a second cell to camp on; camping on the selected second cell; and reporting presence of the repeater node on the selected second cell to a network entity controlling the selected second cell. According to various examples, there is provided an apparatus (e.g. a repeater node) configured to perform this method.

### TECHNICAL FIELD

Certain examples of the present disclosure relate to techniques for a repeater node in idle and/or inactive modes. For example, certain examples of the present disclosure provide methods, apparatus and systems for a Network Controlled Repeater (NCR) in a 3^{rd} Generation Partnership Project (3GPP) 5th Generation (5G) New Radio (NR) network for Radio Resource Control (RRC) Idle mode and/or Inactive mode.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also full-duplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

### DISCLOSURE OF INVENTION

### Technical Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

### Solution to Problem

The scope of the present invention is determined according to the independent claims. Advantageous features are defined in the dependent claims.

According to an aspect of the present disclosure, there is provided a method, of a repeater node for reporting presence, the method comprising: when camping on a first cell of a network, performing cell reselection to select a second cell to camp on; camping on the selected second cell; and reporting presence of the repeater node on the selected second cell to a network entity controlling the selected second cell.

According to various examples, reporting presence of the repeater node is performed using RRC signalling.

According to various examples, reporting presence of the repeater node is performed through RRC Resume procedure.

According to various examples, reporting presence of the repeater node comprises transmitting RRCResumeRequest message to the network entity controlling the second cell.

According to various examples, transmitting the message comprises: reporting presence of the repeater node periodically to the controlling network entity; and/or reporting presence based on receiving a signal from another entity.

According to various examples, reporting presence of the repeater node on the selected cell to the network entity triggers the network entity to notify another network entity controlling the first cell of the presence of the repeater node.

According to various examples, the method comprises: receiving configuration information for use in performing a forwarding function from the network entity after reporting presence to the network entity.

According to another aspect of the present disclosure, there is provided a method, of a repeater node configured to perform a forwarding function in a network, the method comprising: when camping on a first cell of the network, performing cell reselection; in response to a second cell being selected during the cell reselection, camping on the second cell; and modifying the forwarding function.

According to various examples, modifying the forwarding function comprises changing the forwarding function from an on state to an off state.

According to various examples, the off state comprises: preventing a state in which the repeater node forwards data; discarding a forwarding configuration of the repeater node; and/or applying a default forwarding configuration.

According to various examples, the on state comprises one of: performing the forwarding function for all signals; performing the forwarding function selected signals; performing the forwarding function for specific transmissions received from a network entity controlling the first cell; or performing the forwarding function on specific transmissions by the repeater node.

According to various examples, the second cell is different to the first cell.

According to various examples, the method further comprises, while camping on the first cell, performing forwarding based on first configuration information associated with a network entity controlling the first cell or associated with the first cell; wherein modifying the forwarding function comprises performing forwarding based on second configuration information associated with a second network entity controlling the second cell or associated with the second cell.

According to another aspect of the present disclosure, there is provided a method, of a repeater node configured to perform a forwarding function in a network, the method comprising: when camping on a first cell of the network, performing cell reselection; identifying, based on at least one cell selection criterion, a second cell not to be a suitable cell, and modifying the forwarding function based on the identification.

According to various examples, modifying the forwarding function comprises changing the forwarding function from an on state to an off state.

According to various examples, the off state comprises: preventing a state in which the repeater node forwards data; discarding a forwarding configuration of the repeater node; and/or applying a default forwarding configuration.

According to various examples, the on state comprises one of: performing the forwarding function for all signals; performing the forwarding function selected signals; performing the forwarding function for specific transmissions received from a network entity controlling the first cell; or performing the forwarding function on specific transmissions by the repeater node.

According to various examples, when performing the cell reselection, no suitable cell is identified.

According to various examples, the method further comprises, while camping on the first cell, performing forwarding based on first configuration information associated with a network entity controlling the first cell or associated with the first cell; wherein modifying the forwarding function comprises performing forwarding based on second configuration information associated with a second network entity controlling the second cell or associated with the second cell.

According to various examples, the repeater node is in RRC_Inactive mode when camping on the first cell.

According to various examples, the repeater node is a network controlled repeater (NCR).

According to another aspect of the present disclosure, there is provided an apparatus configured to perform the method of any of the above aspects or examples.

According to another aspect of the present disclosure, there is provided a computer program comprising instructions which, when the program is executed by a computer or processor, cause the computer or processor to carry out a method according to any of the above aspects or examples.

Embodiments or examples disclosed in the description and/or figures falling outside the scope of the claims are to be understood as examples useful for understanding the present invention.

Other aspects, advantages and salient features of the invention will become apparent to those skilled in the art from the following detailed description taken in conjunction with the accompanying drawings.

In one embodiment, a method is provided. The method is performed by a network controlled repeater (NCR)-mobile termination (MT) in a wireless communication system, the method comprising: performing a state transition from a radio resource control (RRC) connected state to a RRC inactivate state; performing a cell reselection in the RRC inactive state; and in case that no suitable cell is detected or a cell other than a last serving cell is selected, transferring, to a NCR-forward (FWD), an indication to cease a forwarding.

In another embodiment, a NCR-MT is provided. The network controlled repeater (NCR)-mobile termination (MT) in a wireless communication system, the NCR-MT comprises: a transceiver; and a controller coupled with the transceiver, the controller configured to: perform a state transition from a radio resource control (RRC) connected state to a RRC inactivate state; perform a cell reselection in the RRC inactive state; and in case that no suitable cell is detected or a cell other than a last serving cell is selected, transfer, to a NCR-forward (FWD), an indication to cease a forwarding.

### Advantageous Effects of Invention

According to an embodiment of the disclosure, a wireless communication can be performed efficiently.

### BRIEF DESCRIPTION OF DRAWINGS

FIG. 1 illustrates network architecture of NCR communication according to various examples of the present disclosure;

FIG. 2 is a flow diagram for an NCR configured to perform a forwarding function in a network according to various examples of the present disclosure;

FIG. 3 is a flow diagram for an NCR configured to perform a forwarding function in a network according to various examples of the present disclosure;

FIG. 4 is a flow diagram for reporting NCR presence of an NCR according to various examples of the present disclosure;

FIG. 5 is a diagram for reporting NCR presence according to various examples of the present disclosure;

FIG. 6 illustrates NCR-Specific tracking areas according to various examples of the present disclosure;

FIG. 7 is a flow diagram for configuring measurement relaxation of an NCR according to various examples of the present disclosure;

FIG. 8 is a flow diagram for configuring measurement relaxation of an NCR according to various examples of the present disclosure;

FIG. 9 is a flow diagram illustrating a radio link issue according to the present disclosure;

FIG. 10 is a flow diagram illustrating a method of modifying a forwarding function according to various examples of the present disclosure;

FIG. 11 is a flow diagram illustrating another method of modifying a forwarding function according to various examples of the present disclosure;

FIG. 12 is a flow diagram illustrating another method of modifying a forwarding function according to various examples of the present disclosure;

FIG. 13 is a flow diagram illustrating another method of modifying a forwarding function according to various examples of the present disclosure;

FIG. 14 is a block diagram of an exemplary network entity that may be used in certain examples of the present disclosure.

### MODE FOR THE INVENTION

The content of the following documents is referred to below and/or their content provides background information that the following disclosure should be considered in the context of:
[1] 3GPP TS 38.304; 5G, NR, User Equipment (UE) procedures in idle mode and in RRC Inactive state;
Release 17 (e.g., version 17.2.0)
[2] 3GPP TS 23.501; 5G, system architecture for the 5G System (5GS);
Release 17 (e.g., version 17.7.0)
[3] 3GPP TS 38.300; 5G, NR, NR and NG-RAN Overall description; Stage-2;
Release 17 (e.g., version 17.2.0)

(Note: the example versions shown for each TS are non-limiting, other versions of the TS may be considered also)

Wireless or mobile (cellular) communications networks in which a mobile terminal (e.g., user equipment (UE), such as a mobile handset) communicates via a radio link with a network of base stations, or other wireless access points or nodes, have undergone rapid development through a number of generations. The 3rd Generation Partnership Project (3GPP) design, specify and standardise technologies for mobile wireless communication networks. Fourth Generation (4G) and Fifth Generation (5G) systems are now widely deployed.

3GPP standards for 4G systems include an Evolved Packet Core (EPC) and an Enhanced-UTRAN (E-UTRAN: an Enhanced Universal Terrestrial Radio Access Network). The E-UTRAN uses Long Term Evolution (LTE) radio technology. LTE is commonly used to refer to the whole system including both the EPC and the EUTRAN, and LTE is used in this sense in the remainder of this document. LTE should also be taken to include LTE enhancements such as LTE Advanced and LTE Pro, which offer enhanced data rates compared to LTE.

In 5G systems a new air interface has been developed, which may be referred to as 5G New Radio (5G NR) or simply NR. NR is designed to support the wide variety of services and use case scenarios envisaged for 5G networks, though builds upon established LTE technologies. New frameworks and architectures are also being developed as part of 5G networks in order to increase the range of functionality and use cases available through 5G networks.

In order to provide enhanced network coverage, a variety of different types of network nodes have been developed. For example, a Radio Frequency (RF) repeater may be deployed to amplify and forward any signal that it receives to supplement coverage provided by a regular cell. An enhanced type of repeater node, called a Network-Controlled Repeater (NCR, or NetCR), is currently under development and is a Release 18 Study Item/Work Item (3GPP RP-213700).

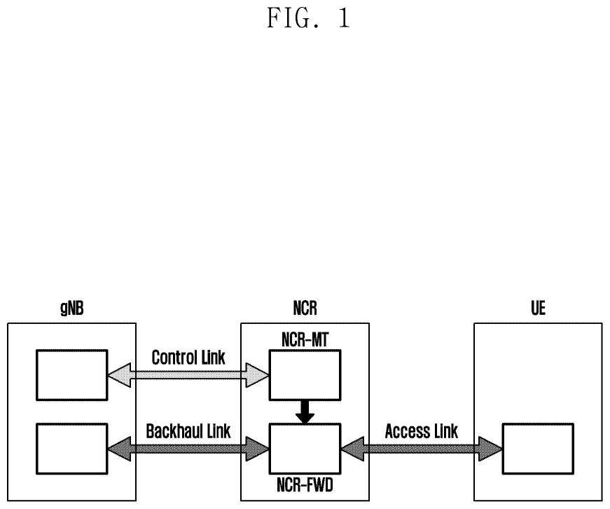

FIG. 1 illustrates the network architecture of NCR communication. As shown, the NCR receives and forwards signals from a base station (e.g. a 5G NR base station, such as a gNB) to a target UE, User Equipment, via an NCR-Fwd link. The NCR also receives control signals from gNB via a control link, terminating at a NCR-Mobile Termination (MT) node. These control signals are used by the NCR-MT to configure the NCR. Once configured, the NCR provides an amplify-and-forward function (NCR-FWD) between the gNB (via backhaul link) and the UE (via access link) that is transparent to the UE. Accordingly, the gNB may communicate with the UE directly or through an NCR.

The NCR-MT control link is intended to function similarly to a UE. Therefore, the NCR-MT has a full protocol stack to correspond to the UE control plane stack, and NCR configurations are signalled similarly to those for a UE. The NCR-MT may therefore be configured to search for serving cells, initiate and perform RRC signalling, transfer NCR capabilities, register to the network, and perform authentication. However, some functionality normally used by a UE may not be applicable to the NCR, and will not be implemented by NCR-MT and/or configured by the network.

RRC protocol, as supported by the NCR, defines modes (or states) of behaviour for a UE according to resource: RRC_Connected, RRC_Idle and RRC_Inactive. In RRC_Connected, the UE is assigned and communicating with a serving base station (e.g., gNB). In RRC_Idle, the UE is in a standby state and is not assigned to a serving base station. The UE camps on, that is, monitors a control channel of, a serving cell, wherein received incoming signals can be utilised during a cell reselection procedure. The UE can initiate RRC Connection establishment to the gNB and move from RRC_Idle to RRC_Connected.

During RRC_Inactive, the gNB maintains the UE context, such that the UE does not need to be fully re-configured for re-connection to the gNB (RRC_Connected). Therefore the UE may move faster to RRC_Connected compared to RRC_idle, e.g. to perform data transmissions. This mechanism is enabled by the UE being configured with a RAN Notification Area (RNA). The UE may move freely within the same RNA without informing the network, and can perform RRC Connection Resume for mobile originated data to move to RRC Connected.

Procedures, or state tasks, for a UE in either an idle or inactive mode (i.e., in RRC_idle or RRC_inactive), include:
PLMN or SNPN (network) selection,
For instance, a UE scans and reports detected PLMN to NAS. E.g., a PLMN is reported as a high quality PLMN if the measured RSRP value is greater than −110 dBm.
Cell selection and reselection,
For instance, a UE selects an (often initial) cell based on two criteria known as the Cell selection criteria. The UE selects a cell that fulfils the criteria, but it is not specified which of the cells that the UE shall select. The criteria are based on the received power level as well as the quality of the signal, which are in turn based on signaled thresholds and measurements.
Cell reselection,
For instance, cell reselection is for the UE to camp on the most suitable cell. In addition to the cell selection criteria, the UE also ranks different cells of the same priority to choose the best cell. The UE also measures on different frequencies that have either high or lower priority, which ensures that the UE always camps on the best cell with the highest priority.
Location registration, for instance:
Tracking Area registration—The UE reports the tracking area information to NAS, and if a UE camps on a new tracking area a Tracking Area Update is triggered. This may also be done periodically.

Procedures (or state tasks) in the RRC_Inactive state include:
RAN Area Registration—The UE performs a RAN-based notification area update when the UE camps on a new cell that does not belong to the current RNA. This can also be done periodically. Thus, RNA update may be applicable only to the RRC_Inactive state.

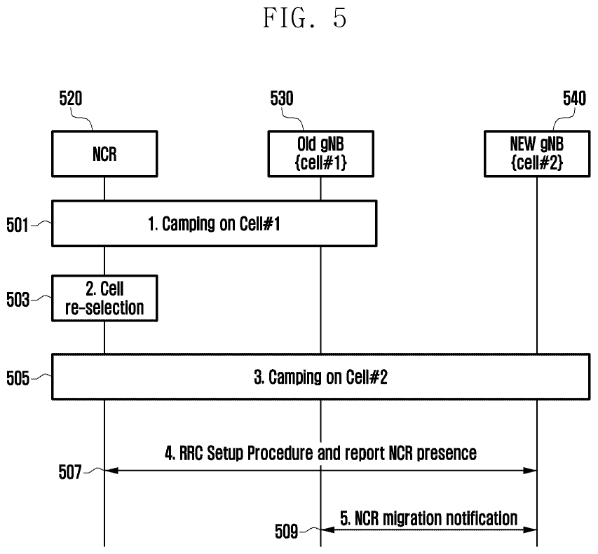

An overview of procedure for a UE in RRC Idle mode is described by FIG. 5.2.2-1, TS 38.304 [1]. As indicated, as the configurations of the NCR correspond to those of a UE, and the NCR supports RRC protocol, the NCR also supports RRC idle and RRC inactive modes.

The above information is presented as background information only to assist with an understanding of the present disclosure. No determination has been made, and no assertion is made, as to whether any of the above might be applicable as prior art with regard to the present invention.

The following description of examples of the present disclosure, with reference to the accompanying drawings, is provided to assist in a comprehensive understanding of the present invention, as defined by the claims. The description includes various specific details to assist in that understanding but these are to be regarded as merely exemplary. Accordingly, those of ordinary skill in the art will recognize that various changes and modifications of the examples described herein can be made without departing from the scope of the invention.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present invention.

The terms and words used herein are not limited to the bibliographical or standard meanings, but, are merely used to enable a clear and consistent understanding of the invention.

Throughout the description and claims of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description and claims of this specification, the singular form, for example “a”, “an” and “the”, encompasses the plural unless the context otherwise requires. For example, reference to “an object” includes reference to one or more of such objects. Throughout the description and claims of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment, example or claim are to be understood to be applicable to any other aspect, embodiment, example or claim described herein unless incompatible therewith.

The skilled person will appreciate that the techniques described herein may be used in any suitable combination.

Certain examples of the present disclosure provide methods, apparatus and systems for performing random access to a network. For example, certain examples of the present disclosure provide methods, apparatus and systems for performing random access to a 3GPP 5G NR network including an NCR. However, the skilled person will appreciate that the present invention is not limited to these examples, and may be applied in any suitable system or standard, for example one or more existing and/or future generation wireless communication systems or standards, including any existing or future releases of the same standards specification, for example 3GPP 5G.

The following examples are applicable to, and use terminology associated with, 3GPP 5G. However, the skilled person will appreciate that the techniques disclosed herein are not limited to 3GPP 5G. For example, the functionality of the various network entities and other features disclosed herein may be applied to corresponding or equivalent entities or features in other communication systems or standards. Corresponding or equivalent entities or features may be regarded as entities or features that perform the same or similar role, function or purpose within the network.

A particular network entity may be implemented as a network element on a dedicated hardware, as a software instance running on a dedicated hardware, and/or as a virtualised function instantiated on an appropriate platform, e.g., on a cloud infrastructure.

Certain examples of the present disclosure may be provided in the form of an apparatus/device/network entity configured to perform one or more defined network functions and/or a method therefor. Certain examples of the present disclosure may be provided in the form of a system (e.g. network or wireless communication system) comprising one or more such apparatuses/devices/network entities, and/or a method therefor.

At least the following problems exist in view of the related art:

As for a UE, the NCR-MT may support configuration in RRC_Connected mode, RRC_Inactive mode, and/or RRC_Idle mode. Therefore cell reselection, and RRM measurements, may be supported for a NCR.

In particular:
When NCR-MT is in RRC_Connected mode, the NCR-Fwd can be on or off following side control information received from the gNB;
After NCR-MT enters RRC_Inactive mode, the NCR_Fwd can be On or OFF following the last configuration received from the gNB;
Release to RRC_Idle is FFS (for further study)
NCR-MT mandatorily supports cell reselection and RRM measurements in RRC_Idle and RRC_Inactive;
In Release 18, NCR-MT does not support handover and RRM measurements in RRC_CONNECTED.

During deployment of an NCR, a control link is needed between the NCR (i.e., terminating at NCR-MT) and the gNB in order to control the NCR transmissions. When the UE connects to an NCR rather than a gNB, the connection (i.e. forwarding function NCR-Fwd) is intended to be transparent to the UE, such that it is unaware of the communication via NCR. However, whilst similarly configured, the reasoning and operation for the NCR performing idle or inactive mode procedures may be different to that of a UE. In particular, whilst NCR supports cell reselection procedure, and RRM measurements, NCR-specific problems may arise. For example, the problem may arise that NCR reselects to a cell (i.e., NCR-MT is camping on a reselected cell) different to the forwarding signals (i.e. a cell where NCR-Fwd is configured to signal from gNB to UE). Furthermore, during cell reselection procedure, a network entity (e.g. gNB, or other network entity) may be unaware of the presence of the NCR.

Accordingly, there is a need to consider the operation of the NCR device, and configuration of the NCR-Fwd link, during RRC Idle and Inactive modes. In addition, there is a need to consider techniques for reporting presence of the NCR following cell reselection.

Accordingly, certain examples of the present disclosure provide one or more techniques for configuration of a repeater node, such as an NCR, or of a forwarding function, such as the NCR-Fwd function, when operating in idle or inactive mode. Other examples of the present disclosure provide one or more techniques for configuration relating to cell reselection according to the state of the forwarding function, such as the NCR-Fwd function. Certain examples of the present disclosure relate to one or more techniques for performing measurement relaxation for cell selection by a repeater node, such as the NCR. Further examples relate to methods for reporting presence of a repeater node, such as the NCR, on or to a cell.

Herein, NCR and gNB may be referred to as different network elements, entities and/or nodes. That is, the skilled person will appreciate that the techniques described herein may be applied to network elements, entities and/or nodes other than NCR and gNB.

Certain examples of the present disclosure provide a method (and corresponding apparatus and/or system(s)), of a repeater node (e.g. NCR) configured to perform a forwarding function in a network, the method comprising: when camping on a first cell of the network, detecting a trigger for performing cell reselection; in response to a second cell being selected during the cell reselection, camping on the second cell, and modifying the forwarding function.

In certain examples, when performing the cell reselection, the method may further comprise identifying, based on at least one cell selection criterion, the second cell to not be a suitable cell based on at least one cell selection criterion.

In certain examples, the detected trigger may be a trigger for performing a network re-selection, and the second cell may be located in a second network different to the network of the first cell.

In certain examples, when the detected trigger is a trigger for performing a network re-selection, and the method may further comprise receiving a signal rejecting a selected network during the network re-selection.

In certain examples, when the detected trigger is a trigger for performing a network re-selection, the method further comprises receiving a signal accepting a selected network during the network re-selection.

In certain examples, the method may further comprise modifying the forwarding function comprises changing the forwarding function from an on state to an off state.

In certain examples, the off state may comprise: preventing a state in which the repeater node forwards data; or forwarding configuration of the repeater node is discarded; and/or a default forwarding configuration is applied.

In certain examples, if the forwarding configuration of the repeater node is discarded, other forwarding configuration may be selected, determined or identified based on information (e.g., configuration information) associated with a network entity controlling the second cell or associated with the second cell. For example, the information (e.g., configuration information) may be specific to the network entity controlling the second cell, or may be specific to the second cell controlled by the network entity, where, optionally, cell-specific information (e.g., cell specific configuration information) may be provided for any/each/all of one of more other cells controlled by the network entity). For example, the method may further comprise performing the forwarding function based on the other forwarding configuration (e.g., when camping on the second cell).

In other examples, modifying the forwarding function comprises performing the forwarding function based on other configuration information (e.g., another forwarding configuration) which is selected or identified based on information associated with a network entity controlling the second cell or based on information associated with the second cell (i.e., cell-specific configuration information).

In certain examples, the method comprises: receiving, from a network entity controlling the first cell or from the network entity controlling the second cell, the information associated with the network entity controlling the second cell or the information associated with the second cell.

In certain examples, the information associated with the network entity controlling the second cell or the information associated with the second cell is received before the trigger for cell reselection is detected or before performing cell reselection. In certain examples, the information associated with the network entity controlling the second cell or with the second cell is obtained from the network entity controlling the first cell or from the network entity controlling the second cell in response to detecting the trigger or in advance of performing cell reselection.

In certain examples, the information associated with the network entity controlling the second cell or with the second cell is received (e.g., from the network entity controlling the first cell or from the network entity controlling the second cell) via system information broadcast (SIB) or RRC signalling (e.g., RRC message).

In certain examples, the other forwarding configuration (e.g., other configuration information) is stored in the repeater node (e.g., in a memory). For example, the other forwarding configuration may have been stored previously to camping on the first cell or prior to detecting the trigger. In certain examples, the other forwarding configuration is stored for a predetermined period of time (e.g., a set amount of time). For example, after expiration of a timer corresponding to the predetermined period or a validity duration of the other forwarding configuration, the forwarding configuration is deleted, discarded or considered outdated by the repeater node. In certain examples, the forwarding configuration (i.e., corresponding to the first cell) is stored for another predetermined period. In such a case, if the repeater node reselects to camp on the first cell again within the other predetermined period (i.e., following camping on the second cell), the repeater node may retrieve the stored forwarding configuration for use in performing the forwarding function for the first cell. In certain examples, a lifetime, or validity duration, of a piece of configuration information is hardcoded.

In certain examples, the method comprises: storing, for each of one or more cells or network entities (e.g., gNBs), configuration information for use in, or as the basis for, performing a forwarding function for the respective cell; selecting the second cell from among the one or more cells or network entities; wherein modifying the forwarding function comprises performing a forwarding function for the second cell based on the configuration information corresponding to the selected second cell (or configuration information corresponding to a network entity controlling the selected second cell, e.g., if gNB-specific configuration information is provided). In certain examples, the method comprises performing the forwarding function for the first cell based on other configuration information, while the repeater node is camped on the first cell.

In certain examples, the method comprises: storing information on one or more cells or network entities (e.g., gNBs) for which the same configuration information can be used (e.g., in, or as the basis for, performing a forwarding function); selecting the second cell from among the one or more cells indicated in the information on the one or more cells or network entities; and performing the forwarding function for the second cell based on the configuration information. In certain examples, the configuration information is received from the network entity controlling the first cell and, optionally, the second cell is selected only from among the one or more cells or network entities (for example, cell reselection is performed only with the one or more cells or network entities). In certain examples, the method comprises: performing the forwarding function for the first cell based on the configuration information, while the repeater node is camped on the first cell; wherein the forwarding function is not modified.

In certain examples, the on state may comprise one of: performing the forwarding function for all signals; performing the forwarding function for selected signals; performing the forwarding function for specific transmissions received from a/the network entity controlling the first cell; and performing the forwarding function on specific transmissions by the repeater node.

In certain examples the first cell may be selected as the second cell.

Certain examples provide a method of a repeater node (e.g. NCR) configured to perform a forwarding function in a network, the method comprising: camping on a cell in the network; and whilst the forwarding function (e.g. NCR-Fwd) is on: configuring to turn off cell reselection whilst keeping the forwarding function on; or performing cell reselection based on modified cell reselection parameters in response to detecting a trigger for performing cell reselection.

In certain examples, the modified cell reselection parameters may be received in system information, or a RRC message.

In certain examples, the modified cell reselection parameters may be met for a configured period of time.

In certain examples, the modified cell reselection parameters may be at least one of: Qrxlevmin; Qrlevminoffset; Pcompensation; QoffsetTemp; Qqualmin; Qqualminoffset.

In certain examples, the cell reselection may be turned off for a configured period of time.

In certain examples, the configured period of time may be one of: a signalled or pre-configured time duration following turning on of the forwarding function; a period of time until the forwarding function changes to off; and until a cell selection criterion is met.

In certain examples, performing cell reselection based on the modified cell reselection parameters comprises: performing cell reselection with one or more network entities associated with first configuration information, wherein the first configuration information is associated with a first network entity controlling the cell (or with the cell controlled by the first network entity—e.g., the configuration information may be cell specific or network entity specific), and the one or more network entities are indicated in information received from the first network entity. For example, the one or more network entities and the first network entity (or the cell) are associated with the same configuration information, such that forwarding when camped on the cell is performed using the same configuration information as forwarding that will be performed after cell reselection (to a cell controlled by a selected one of the one or more network entities). In some cases, the first network entity is the selected one of the one or more network entities—i.e., the repeater node selects another cell of the first network entity to camp on.

In certain examples, performing cell reselection based on the modified cell reselection parameters comprises: performing cell reselection only with one or more network entities for which second configuration information, for use in performing the forwarding function, has been obtained prior to performing cell reselection. For example, the second configuration information may include configuration information for each of the one or more network entities (or for at least one cell controlled by each of the one or more network entities—e.g., the configuration information may be cell specific or network entity specific), and may be received from a network entity controlling the cell. In some cases, the first network entity is the selected one of the one or more network entities—i.e., the repeater node selects another cell of the first network entity to camp on.

Certain examples of the present disclosure provide a repeater node (e.g. NCR) for reporting presence, the method comprising: when camping on a first cell of a network, detecting a trigger for performing cell reselection; performing cell reselection to select a second cell to camp on; camping on the selected second cell; and transmitting a message reporting presence of the repeater node on the selected second cell to a network entity (e.g. gNB) controlling the selected second cell.

In certain examples, transmitting the message may comprise: reporting presence of the repeater node periodically to the controlling network entity; and/or reporting presence based on receiving a signal from another entity.

In certain examples, the reporting presence of the repeater node may be performed using RRC signalling.

In certain examples, the reporting presence of the repeater node on the selected cell to the network entity may trigger the network entity to notify another network entity controlling the first cell of the presence of the repeater node.

In certain examples, the network entity is a base station (e.g., a 5G NR base station, e.g., a gNB).

Certain examples of the present disclosure provide a method of a repeater node (e.g., NCR) for reporting presence, comprising: when camping on a first cell of a network, detecting a trigger for performing cell reselection; performing cell reselection to select a second cell to camp on; camping on the selected second cell; determining the repeater node to be in a new location area different to a location area of the first cell; and transmitting a message reporting presence of the repeater node in the new location area to a network entity.

In certain examples, the location area may be one of a tracking area or a notification area.

In certain examples, the method further comprises transmitting a message reporting presence of the repeater node on the selected second cell to a network entity controlling the selected second cell.

Certain examples of the present disclosure provide a method of a repeater node (e.g., a NCR) for configuring measurement relaxation, comprising, while the repeater node is operating in an idle or inactive mode in which measurement relaxation is instructed by a network entity, one of: performing measurement relating to cell reselection by the repeater node without applying measurement relaxation; or determining whether a forwarding function of the repeater node is on, and performing measurement relating to cell reselection by the repeater node based on the determination.

In certain examples, performing measurement based on the determination may further comprise: if the forwarding function of the repeater node is off, performing measurement relating to cell reselection without configuring measurement relaxation parameters; or if the forwarding function of the repeater node is on, performing measurement relating to cell reselection by configuring measurement relaxation parameters.

Certain examples of the present disclosure provide an apparatus (e.g., a NCR) for performing a forwarding function in a network, the apparatus being configured to perform the method according to any aspect, example, claim or embodiment described herein.

Certain examples of the present disclosure provide an apparatus (e.g., a NCR) being configured to perform the method according to any aspect, example, claim or embodiment described herein.

Certain examples of the present disclosure provide an apparatus (e.g., a NCR) for configuring measurement relaxation, the apparatus being configured to perform the method according to any aspect, example, claim or embodiment described herein.

Certain examples of the present disclosure provide a computer program comprising instructions which, when the program is executed by a computer or processor, cause the computer or processor to carry out a method according to any aspect, example, claim or embodiment described herein.

Certain examples of the present disclosure provide a method of a network entity (e.g. gNB) controlling a first cell in a network, comprising: receiving notification of a repeater node camping on the first cell; in response to the notification, notifying another network entity of the presence of the repeater node on the first cell, the other network entity controlling a second cell on which the repeater node camped prior to the first cell.

In certain examples, the received notification of the repeater node camping on the first cell may be performed using RRC signalling.

Certain examples of the present disclosure provide a network entity controlling a first cell in a network, the network entity being configured to perform the above-example method.

With reference to the present disclosure, the NCR-Fwd of the NCR (i.e., a forwarding function of a repeater node) will be defined as either ON or OFF; i.e., operating, or configured to operate, in either an ON state or an OFF state. In various examples, an ON state of the NCR is intended to define a state of forwarding, or being configured to perform a forwarding function for, signals between a base station (e.g. gNB) to a target UE. In some examples, when operating in the ON state, the NCR-Fwd may forward all signals from the gNB to the UE. In some examples, it may forward only selected signals. Information on selected signals to forward may be received via signalling, or instruction from a network entity etc. In another example, based on a connected gNB (e.g., donor gNB), the NCR may forward the full bandwidth of the donor gNB, which is known from knowing what frequencies the donor gNB operates on. In some examples, the NCR-Fwd operating in the ON state may be configured to forward signals received on specific transmissions from the gNB; and/or forward signals to the UE on specific transmissions generated by the NCR-Fwd. These transmissions may be one or more beams, for example, each having one or more allocated SIB index. In other examples, the specific transmissions may refer to a set of allocated SIB indices.

Similarly, in various examples of the present disclosure, where NCR-Fwd is described as being OFF, or in an OFF state, this defines a state of the NCR not forwarding, or not currently being configured to perform a forwarding function, for signals between a base station (e.g. gNB, such as a gNB controlling a cell the NCR camped on before cell reselection) and a target UE. In some examples, the NCR-FWD is turned off, such that it is not configured to, and/or does not provide, any forwarding of signals to the UE. In some examples, the NCR-Fwd in an OFF state refers to any state or configuration related to NCR-Fwd being in an off state. In some examples, the NCR-Fwd being in an OFF state indicates that NCR-Fwd does not perform, or stops performing, forwarding using a configuration (e.g., configuration information) associated with a cell the NCR camped on previously (e.g., prior to cell reselection). In some examples, the NCR-Fwd being in an OFF state indicates that the NCR-Fwd does not perform, or stops performing, forwarding for a cell (or a base station, e.g., gNB) on which the NCR camped previously (e.g., prior to cell reselection). The NCR-Fwd being in an OFF state may indicate that the NCR-Fwd does not forward anything, or that the forwarding configuration is discarded (e.g., such that a new forwarding configuration/new configuration information (e.g., cell-specific or base station-specific) is used) and/or a default forwarding configuration is applied. For example, said forwarding configuration may refer to beam information, which indicates slot and/or indices information, for signal transmission.

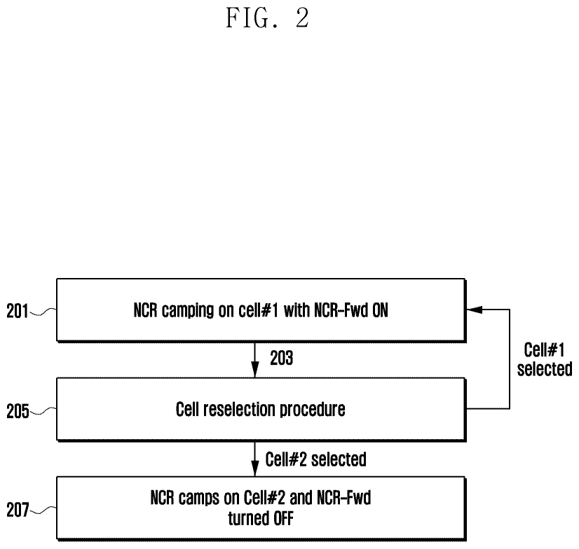

FIG. 2 illustrates a flowchart of a method of a repeater node (e.g. an NCR) performing a forwarding function. For example, the method of FIG. 2 may be performed by an NCR as described with reference to FIG. 1, wherein the NCR performs a forwarding function (e.g. via NCR-Fwd) from a base station (e.g. gNB) to a UE. As described, the NCR-Fwd function may be configured in accordance with control signals received from gNB via a control link to NCR-Mobile Termination (MT) (NCR-MT). It will be appreciated that one or more of the operations shown in FIG. 2 may be omitted, replaced and/or re-ordered, thereby providing additional examples of the present disclosure.

In first step 201, the NCR is in an idle mode or inactive mode (i.e. RRC_Idle, or RRC_Inactive) and camping on a first cell (e.g., Cell #1) of a network. In some examples, the first cell may be an initial cell, that is, a cell of the an initially selected network that fulfils cell selection criteria. Whilst camping (i.e., monitoring the control channel) on this first (serving) cell, the NCR-MT, through the control link, is configured to receive signals from a base station (e.g. gNB) controlling this first cell. In this example, NCR-Fwd is configured in an ON state, in that it is providing (or configured to provide) a forwarding function on NCR-Fwd to a target UE of the network. That is, as described here and in the below examples, it may be understood that when camping on a cell, the NCR is in either RRC_Idle or RRC_Inactive mode.

In various examples, the NCR (e.g. NCR-MT) transitions from RRC_Connected state to RRC_Inactive state and the NCR (e.g. NCR-Fwd) continues to amplify-and-forward RF signals (i.e., while and/or after the transitioning, NCR-Fwd is in an ON state).

At step 203, the NCR may receive or detect a trigger (e.g., the NCR may be triggered) for performing a cell reselection (e.g., the NCR may detect a situation in which to reselect cell). Any suitable trigger by which a cell (or network) reselection may be used in various examples of the present disclosure. Some non-limiting examples will be described below. In an example, to determine that a trigger for cell reselection when in an idle (or inactive) state may be in response to cell reselection criteria being met. Such cell reselection criteria may be based on measurements of serving and neighbouring cells performed by the NCR. When the performed measurements (e.g., measurement parameters) meet a cell reselection criteria (e.g., a cell reselection trigger, for example, based on cell ranking) the cell reselection procedure is triggered at step 205.

At step 205, during the cell reselection procedure, the NCR may determine, or detect/identify, a different cell, and subsequently may determine to camp on this cell. For example, the NCR may (re) select a cell, as a suitable cell, other than the first (serving) cell. In various examples, a suitable cell may be determined or selected in view of criteria specified in TS 38.304 [1], e.g., referring to the definition of a suitable cell found therein.

In some examples, as indicated in the example of FIG. 2, a/the reselected cell may be determined as the first cell, i.e. that the NCR remains camped on the first cell or is considered to reselect to the first cell. This may arise if no suitable cell is found during cell-reselection (for example, if the cell selection criteria are not met, and/or a gNB of a cell is not NCR-capable). In the example where the NCR remains on the first cell in response to a cell reselection procedure being triggered, the NCR-Fwd may be modified, e.g., from an ON to an OFF state. This may prevent NCR-Fwd from forwarding (or continuing to forward) signals to the UE when there is an insufficient connection to a base station (e.g. gNB) controlling the first cell of the network. In general, if no suitable cell is detected during the cell reselection procedure, NCR-MT may instruct or indicate to NCR-Fwd to cease forwarding (e.g., turn forwarding to an OFF state). That is, in various examples, when the NCR (e.g., NCR-MT) is in RRC_Inactive state, the NCR-Fwd ceases to amplify-and-forward RF signals if no suitable cell is detected.

In some examples, if the NCR (i.e., NCR-MT) cannot find any suitable cell, but only finds acceptable cell(s) (e.g., referring to the definition of an acceptable cell found in TS 38.304 [1]) the NCR-MT considers to not have detected any cells at all, i.e., the NCR-MT does not consider acceptable cell(s) and does not camp on, or determine to camp on, an acceptable cell. This is because, for instance, acceptable cell(s) are only used for a wireless device to originate emergency calls and receive emergency notifications, which may not be applicable to a NCR device. During this time (e.g., while only finding acceptable cell(s)) the NCR-Fwd will remain OFF. Example implementations of such behaviour comprise one or more of:
When performing cell reselection, for example, NCR (i.e., NCR-MT) does not consider (e.g., disregards, ignores, omits etc.) acceptable cell(s) (e.g., any/all acceptable cells);
NCR (e.g., NCR-MT) does not camp on an acceptable cell, or will not determine to camp on an acceptable cell; or
If no suitable cell(s) are found (e.g., when performing cell reselection), or if only acceptable cell(s) are found (e.g., when performing cell reselection), NCR (e.g., NCR-MT) considers no cell to have been found.

In each case, the forwarding function (i.e., NCR-Fwd) may remain turned OFF (according to any definition of turned OFF found herein) or may turn OFF (if not already turned OFF). Further, NCR-Fwd may be/remain turned OFF until a condition is satisfied, such as NCR-MT camping on a suitable cell or identifying a suitable cell to camp on.

In further examples, when performing the cell reselection procedure, the NCR may determine another cell as a better cell to camp on. For example, at step 207, the NCR may determine Cell #2 as a better cell to camp on, and the NCR may reselect to camp on this cell. When a different (i.e., another) cell to the first cell is selected during the cell reselection procedure, the NCR-Fwd may be modified, e.g., from an initial ON state to an OFF state.

In the above example, the NCR-Fwd is modified from an ON to an OFF state in response to a cell being selected during the cell reselection procedure (e.g. following step 205). In other examples, the NCR-Fwd may be modified from an ON to an OFF state in response to a cell reselection trigger being received (i.e. step 203). In some of the above examples, the NCR may be configured to modify NCR-Fwd based on actions performed by the NCR-MT.

By modifying the NCR-Fwd from an ON state into an OFF state in response to cell reselection, or triggering of cell reselection, a problem where the NCR-MT is camping on the second (reselected) cell whilst NCR-Fwd is performing a forwarding function from a controlling gNB to the UE of the first cell may be resolved or mitigated.

In further examples, the detected trigger (i.e. trigger 203 as show in FIG. 2) may be a trigger for performing a network (e.g. PLMN) reselection. The trigger for network reselection can be triggered over the Non Access Stratum (NAS), e.g., based on any type of suitable procedure. It is apparent that any suitable trigger may be used here by which network (e.g. PLMN) selection may be triggered. In non-limiting examples, PLMN selection may be triggered by NAS when powering on the wireless device or when ordered by the Core Network in response to receiving a request.

In an example, and following detection of the trigger for network reselection, the NCR may receive a signal over the NAS from an external network entity for accepting or rejecting the selected network. If this signal indicates that the reselected network is rejected, the NCR may remain on the first cell (e.g., Cell #1), and, in some examples, NCR-Fwd may be modified from an ON to an OFF state.

If this signal indicates that the reselected network is accepted, the NCR may select a new initial cell of the accepted network (i.e., a cell reselection procedure is performed), and may camp on this new (i.e. selected) cell. In response to reselecting to camp on this cell, NCR-Fwd may be modified from an ON to an OFF state (e.g., at step 207 of FIG. 2). In other examples, NCR-Fwd may be modified from an ON to an OFF state on receipt of the trigger for performing a network reselection, and in further examples, in response to receipt of the signal accepting the selected network (i.e., prior to network change).

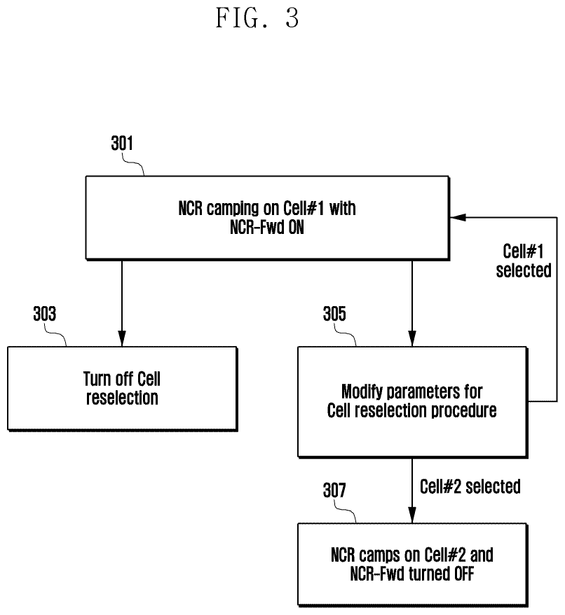

FIG. 3 is a flowchart of a further method of a repeater node (e.g. an NCR) performing a forwarding function in a network, according to an example of the present disclosure. In this example, and similarly to FIG. 2, the method of FIG. 3 may performed by an NCR as described with reference to FIG. 1. It will be appreciated that one or more of the operations shown in FIG. 3 may be omitted, replaced and/or reordered, thereby providing additional examples of the present disclosure.

At first step 301, NCR may be in an idle or inactive mode (e.g., RRC_Idle or RRC_Inactive) and camping (or monitoring) a first cell (e.g., Cell #1) of a network, and the NCR-Fwd is operating in an ON state. That is, the NCR-Fwd may be performing a forwarding function for signals from a controlling base station (e.g., gNB) of the first cell to a UE in the network.

In an example, whilst the NCR-Fwd is determined to be in the ON state, the NCR may be configured to turn off cell reselection, at step 303. In other words, the NCR-Fwd remains ON, but procedure for cell reselection is not performed, even if a trigger, such as described with reference to step 203 of FIG. 2, is received or detected. This may prevent the situation where NCR-MT may reselect to camp on a different cell from a gNB providing data to be forwarded via the NCR-Fwd function. Turning off cell reselection may ensure that the NCR stays with the donor gNB (e.g., gNB of the first cell) and does not camp on a different cell.

In some examples, turning off cell reselection comprises that all cell reselection operations are turned off for the duration of NCR-Fwd being in an ON state. In other examples, the cell reselection procedure may be turned off for a configured amount of time. The configured amount of time may be at least one of: a signalled or pre-configured time duration following NCR-Fwd being configured in (or turned to) an ON state; a period of time until NCR-Fwd changes to an OFF state; or until a cell reselection criterion (i.e. based on a cell ranking) is met.

The cell selection criterion may correspond to the criterion being fulfilled as detailed in TS 38.304 [1] (e.g., refer to clause 5.2.3.2), in respect of a UE, as based on a combination of two conditions:
Srxlev>0 AND Squal>0

That is, 1) received signal level is above threshold, and 2) received signal quality is above a threshold, and where:

Srxlev=Qrxlevmeas−(Qrxlevmin+Qrxlevminoffset)−Pcompensation−Qoffsettemp

Squal=Qqualmeas−(Qqualmin+Qqualminoffset)−Qoffsettemp

These terms are defined in TS 38.304 [1] (5.2.3.2) as follows:

| | |
|---|---|
| Srxlev | Cell selection RX level value (dB) |
| Squal | Cell selection quality value (dB) |
| Qoffsetₜₑₘₚ | Offset temporarily applied to a cell as specified in TS 38.331 [3] (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE supports SUL |
| | frequency for this cell, Qᵣₓₗₑᵥₘᵢₙ is obtained from q-RxLevMinSUL, if |
| | present, in SIB1, SIB2 and SIB4, additionally, if Q_{rxlevminoffsetcellSUL} is |
| | present in SIB3 and SIB4 for the concerned cell, this cell specific |
| | offset is added to the corresponding Qrxlevmin to achieve the |
| | required minimum RX level in the concerned cell; |
| | else Qᵣₓₗₑᵥₘᵢₙ is obtained from q-RxLevMin in SIB1, SIB2 and SIB4, |
| | additionally, if Q_{rxlevminoffsetcell} is present in SIB3 and SIB4 for the |
| | concerned cell, this cell specific offset is added to the corresponding |
| | Qrxlevmin to achieve the required minimum RX level in the |
| | concerned cell. |
| Q_{qualmin} | Minimum required quality level in the cell (dB). Additionally, if |
| | Q_{qualminoffsetcell} is signalled for the concerned cell, this cell specific |
| | offset is added to achieve the required minimum quality level in the |
| | concerned cell. |
| Q_{rxlevminoffset} | Offset to the signalled Qᵣₓₗₑᵥₘᵢₙ taken into account in the Srxlev |
| | evaluation as a result of a periodic search for a higher priority PLMN |
| | while camped normally in a VPLMN, as specified in TS 23.122 [9]. |
| Q_{qualminoffset} | Offset to the signalled Q_{qualmin} taken into account in the Squal |
| | evaluation as a result of a periodic search for a higher priority PLMN |
| | while camped normally in a VPLMN, as specified in TS 23.122 [9]. |
| P_{compensation} | For FR1, if the UE supports the additionalPmax in the NR-NS- |
| | PmaxList, if present, in SIB1, SIB2 and SIB4: |
| | max(P_{EMAX1} − P_{PowerClass}, 0) − (min(P_{EMAX2}, P_{PowerClass}) − min(P_{EMAX1}, |
| | P_{PowerClass})) (dB); |
| | else: |
| | max(P_{EMAX1} − P_{PowerClass}, 0) (dB) |
| | For FR2, P_{compensation} is set to 0. |
| | For IAB-MT, P_{compensation} is set to 0. |

However, in some examples, the cell selection criterion or cell-ranking may be fulfilled by conditions that are set differently for a NCR. In particular, the NCR may be configured with modified, or NCR-specific parameters, as will be discussed below.

Referring back to FIG. 3, and step 301, the NCR is camping on the first cell and NCR-Fwd is in an ON state. At step 305, as an alternative example to step 303, whilst the NCR-Fwd is determined to be in an ON state, the NCR may configured with modified parameters for performing cell reselection procedure. In other words, the cell reselection criterion is fulfilled by different (e.g., NCR-Specific) threshold parameters in comparison to UE parameters. These NCR-specific parameters may include at least the following parameters: Qrxlevmin; Qrlevminoffset; Pcompensation; QoffsetTemp; Qqualmin; Qqualminoffset, contributing to the cell selection criteria conditions Srxlev and Squal, as detailed above.

In some examples, these parameters may be signalled in broadcast system information, over system information block(s), SIB(s), such as SIB1, SIB2, SIB3, or SIB4. In other examples, these parameters may be signalled in RRC messages. The NCR may be configured to perform cell reselection procedure only when the cell selection criterion or cell-ranking criterion, as based on NCR-specific parameters, are fulfilled for more than a certain amount of time or are fulfilled within a period of time (e.g., a specified period). In an example, this may be in a range of seconds, e.g., from 1 to 100 seconds: {1, 2, 5, 10, 15, 25, 50, 100}. This time may be configured and/or signalled in addition to, or separate to, the NCR-specific parameters, as detailed above. In other examples, this amount of time may be pre-configured at the NCR.

In an example, the cell reselection procedure may be performed according to the modified parameters, at step 305. At step 307, the NCR may reselect to camp on a different cell (e.g., Cell #2, being a suitable cell (or, if necessary, an acceptable cell)), and NCR-Fwd may be turned off (corresponding to step 207 of FIG. 2). In another example, Cell #1 may be selected at step 305, and the NCR may select (e.g., remain) camping on the same cell (Cell #1), and NCR-Fwd may be modified from an ON to an OFF state.

According to the above-detailed examples, by configuring the cell reselection criteria of the NCR, the NCR device (e.g., NCR-MT) is discouraged from camping on another cell whilst NCR-Fwd is on.

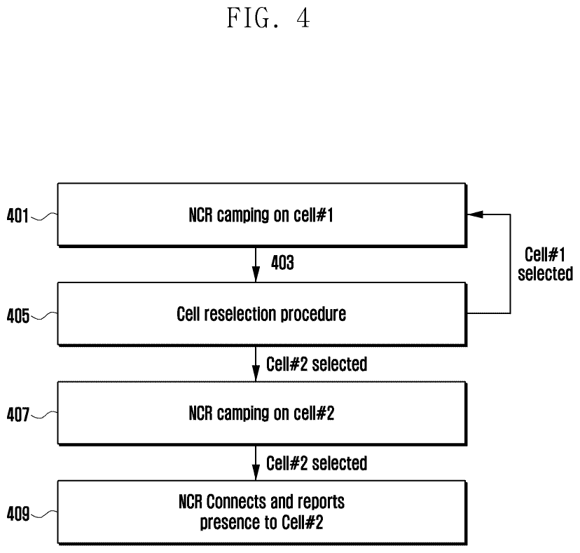

FIG. 4 is a flowchart of a further method of a repeater node (e.g. an NCR) reporting presence according to an example of the present disclosure. For example, when camping on a new cell (i.e. following cell reselection), the network (and a controlling network entity) may be unaware of the presence of the NCR on the cell. The NCR may be configured to establish a connection (i.e. with the gNB) and report when camping on a new cell. It will be appreciated that one or more of the operations shown in FIG. 4 may be omitted, replaced and/or re-ordered, thereby providing additional examples of the present disclosure. It will further be appreciated how, in various examples of the present disclosure, the method of FIG. 4 may be combined with another method disclosed herein, such as that of FIG. 2 or FIG. 3.

Referring to FIG. 4, in step 401, the NCR may camp on a first cell (e.g., Cell #1). The NCR may be in either Idle or Inactive mode (e.g., RRC_Idle, RRC_Inactive). In the example shown in FIG. 4, the forwarding function (NCR-Fwd) may either be in either an ON or OFF state. In some examples, whilst the NCR remains camping on this first cell (Cell #1), the NCR may periodically report its presence to a network entity (e.g., the gNB controlling the cell).

At step 403, a cell reselection trigger may be received or detected. Any suitable trigger may be used or described, and may herein be defined similarly to cell reselection trigger 203 with reference to FIG. 2. Following receipt of this trigger, the NCR may proceed to a cell reselection procedure at step 405. The NCR may reselect cell to camp on either a different cell at step 407, and in other examples, may select to remain on the same cell as a result of performing cell reselection. In some examples, the NCR may report its presence to the gNB (of the first cell) to indicate that it remains camping on the first cell. For example, the NCR may continue to periodically report its presence whilst it remains camping on the first cell.

In various examples, when the second cell is selected at step 407, the NCR reselects cell to camp on the second cell (Cell #2). Subsequently, at step 409, the NCR may transmit a message reporting presence of the NCR on this second cell to a network entity (e.g. gNB) controlling the second cell. The message may be transmitted in response to starting camping on the second cell, i.e. on/following connection to the second cell. In other examples, the NCR may periodically report presence on the second cell to the controlling gNB (e.g., NCR reports presence after camping on second cell according to the timing of the periodic reporting, e.g., on a reporting occasion). In other examples, the NCR may report presence to the gNB when receiving a signal from another entity. For example, the NCR may be turned off, but monitoring activity from another network entity, and the NCR may transmit a message indicating presence on the second cell on detection of said entity.

In some examples, the reporting presence of the repeater node in any of the above examples, is performed using RRC signalling. In examples, this can be done through the NCR performing RRC Connection establishment procedure (RRCSetupRequest-RRCSetup-RRCSetupComplete). In examples, it can also be performed through the RRC Resume procedure (RRCResumeRequest-RRCResume-RRCResume-Complete). In examples, the NCR presence update can be done through indicating that the NCR device is updating its presence in any of the RRC connection establishment request message—i.e. RRCSetupRequest, RRCResumeRequest, RRCConnectionEstablishmentRequest, or RRCConnectionResumeRequest.

In various examples, upon performing cell reselection, the NCR (e.g. NCR-MT) reports presence (e.g., through RRC Resume procedure) to receive configuration information from the gNB controlling the cell selected in the cell reselection, where the NCR (e.g. NCR-Fwd) performs forwarding based on the configuration information.

It will be appreciated that various examples of the present disclosure also include a network entity (e.g., a base station, such as a gNB) which is configured to operate according to the method of FIG. 4, in the sense of relating to the base station controlling the first cell or the base station controlling the second cell. For example, various examples relate to a network entity configured to receive an indication that a NCR (i.e., repeater node) is camped on a cell controlled by the network entity, following cell reselection by the NCR. Optionally, the network entity may report presence of the NCR on the cell controlled by the network entity to another network entity which controls a cell on which the NCR was previously camping.

In various embodiments of the present disclosure, an NCR may be configured to periodically report presence to a network entity, such as a network entity controlling a cell on which the NCR has camped on. For example, reporting presence is not triggered (or not exclusively triggered by) cell or network (e.g., PLMN) reselection, but rather the NCR is configured to periodically report presence on a cell such that a gNB, for example, controlling the cell will (i.e., eventually) be informed of the presence of the NCR on that cell.

Referring FIG. 5, this illustrates an further example for reporting presence of a repeater node (e.g. NCR). It will be appreciated that one or more of the operations shown in FIG. 5 may be omitted, replaced and/or re-ordered, thereby providing additional examples of the present disclosure. It will further be appreciated how, in various examples of the present disclosure, the method of FIG. 5 may be combined with another method disclosed herein, such as that of FIG. 2 or FIG. 3.

The NCR 520 may be in either an idle or inactive mode (e.g., RRC_Idle or RRC_Inactive) and, at step 501, is initially camping on the first cell (e.g., Cell #1), the first cell being controlled by a first gNB 530. The NCR 520 may, at step 503, perform a cell reselection procedure, for example, in response to a cell reselection criterion (see FIG. 2, step 203) being fulfilled. Following the cell reselection procedure, at step 505, the NCR 520 may reselect and camp on the second cell, the second cell controlled by a second gNB 540.

In this example, the second gNB 540 controlling the second cell may remain unaware of the presence of the NCR 520 camping on the second cell. For instance, when in idle or inactive mode, the NCR 520 is camping on (monitoring) the serving cell thus not actively communicating with the controlling base station.

The NCR 520 may indicate presence to the gNB 540 of the new (i.e., second) cell. For example, to support the performing of a forwarding function (NCR-Fwd) from the gNB to the target UE, the NCR 520 may indicate presence to the gNB 540 of the new (i.e., second) cell. As set out at step 507, following reselection to the second cell, the NCR may transmit a message reporting its presence on the second cell to the gNB 540. In some examples, as shown at step 507, this can be performed within an RRC message (e.g., RRC Setup Procedure). However, it will be appreciated that this example is non-limiting, and it may be otherwise signalled.

On receipt of the reporting message at the second gNB 540, at step 509, the second gNB 540 may then transmit (i.e., is arranged to transmit on or following receipt of the message), a notification (e.g., inter-gNB notification) to the first gNB 530 indicating migration of the NCR 520 from the first cell to the second cell or, more generally, presence of the NCR 520 on the second cell. This notification may be referred to as an NCR migration notification, and may be in a separate inter-gNB message, or a flag or information element of an existing message. In some non-limiting examples, this existing message may comprise one of: Handover Success, Handover Report, Failure Indication. Thus, the first gNB 530 controlling the first cell may be made aware of the migration away of the NCR 520.

In some examples, the second cell may be within the same tracking area, or RAN notification area (RNA), such that the NCR 520 may move freely within these areas without initiating a location update. Such location updates may comprise a tracking area update and/or an RNA update, respectively.

In a further example, when in either RRC_Idle or RRC_Inactive modes, the NCR 520 may report presence through utilising Tracking Area configurations. In a particular example, and referring back to FIGS. 4 and 5, after performing cell reselection procedure, the selected second cell may be determined by the NCR 520 to be in a different tracking area to the area of the first cell or, more generally, the NCR 520 may determine that it is in a different tracking area. In various examples, these tracking areas may be NCR-specific, that is, configured differently to tracking areas utilised by UE for reporting presence, as described below.

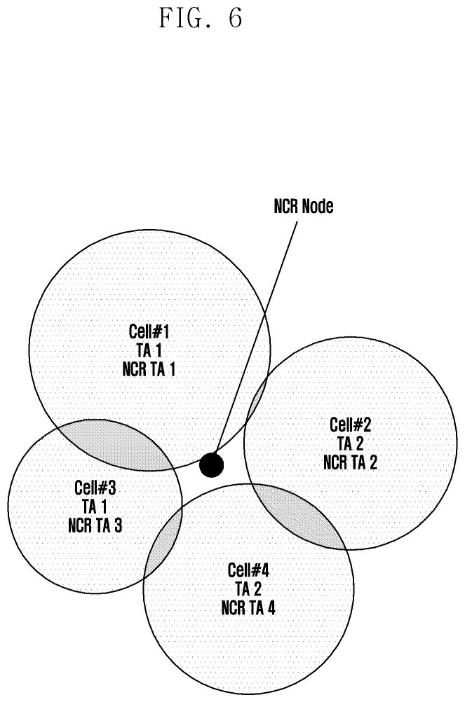

FIG. 6 illustrates an example of a configuration of tracking areas and NCR-specific tracking areas for a repeater node (e.g. NCR). It will be appreciated that one or more of the operations shown in FIG. 6 may be omitted, replaced and/or re-ordered, thereby providing additional examples of the present disclosure. It will further be appreciated how, in various examples of the present disclosure, the method of FIG. 6 may be combined with another method disclosed herein, such as that of FIG. 2, FIG. 3, FIG. 4 or FIG. 5.

FIG. 6 shows Cells #1-#4, which are arranged, or covered, by tracking areas TA1-TA4, and NCR tracking areas, NCR TA1-4. In this example, tracking areas TA 1 and TA2 correspond to mobile tracking areas of the NG-RAN, for example as set out in 3GPP TS 23.501 [2]. Such areas correspond to regions through which the idle mobile (i.e. a UE in an idle state) may move without needing to inform the network. In this example, each cell (Cell #1-#4) is associated with one of tracking areas TA1 or TA2, as shown. Specifically, Cells #1 and #3 lie within TA1 and Cells #2 and #4 lie within TA2.

In the example shown in FIG. 6, each cell may also be associated with an NCR-Specific tracking area, NCR TA1-4. These may be termed NCR Tracking Areas (NCR TA, or nTA), and represent regions through which the NCR (in idle, or inactive state) may move without needing to inform the network. In the example shown, it can be seen that each of cells #1-#4 are located, respectively, in NCR TA1-4. However, in other examples it is apparent that one or more cells may lie within each NCR TA (nTA). In comparison to tracking areas (e.g., TA), the NCR TAs define different sizes (for example, in area or cells) of the NG-RAN, within which an NCR may freely move.

For example, following cell reselection, and on selecting to camp on a second cell, the NCR may determine that the new (second) cell to be in a different location area to the first cell prior to reselection. The location area may correspond to either a tracking area, or a RAN notification area (or simply, notification area). In some examples, the NCR message indicating presence in a new location area may also include indication of presence in the current (second) cell.

In an example, when the NCR is camping on the second cell, and the second cell is determined to be in new tracking area (or new tracking area lies outside a tracking area list), the NCR may transmit a message to a network entity (e.g., an AMF) indicating presence in the new tracking area. In some examples the indication of presence may be performed within a registration update message. In other examples, the indication of presence in a new tracking area may be a separate message, e.g. NCR presence update. In further examples, the NCR may report presence through an existing message or report, e.g., RRC signalling.

Whilst the example of FIG. 6 illustrates NCR tracking areas, it may similarly understood that one tracking area can be further divided into a RAN notification areas, RNAs, as indicated in 3GPP TS 38.300 [3] (e.g., referring to clause 9.2.2.3). In some examples, the NCR-specific tracking areas, nTAs, may be further divided into NCR-specific RNA areas.

In an example, when in RRC_Inactive, the NCR may determine the location area of the second cell to be a new RAN notification area. In this example, the NCR may report presence to a controlling network entity (e.g., a gNB) of the second cell through the use of RAN Notification Area Update (RNAU). In this example, the NCR may report presence through transmittal of a message indicating presence in the new RNA and/or cell. In some examples, the indication of presence in a new RNA can be a separate message, e.g., RNA update. In other examples, the NCR can report presence through an existing message or report.

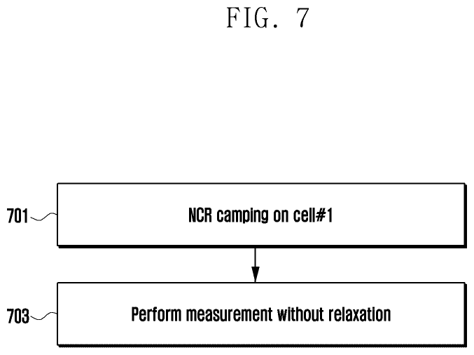

FIG. 7 is an example of configuring measurement relaxation for a repeater node (e.g., an NCR). It will be appreciated that one or more of the operations shown in FIG. 7 may be omitted, replaced and/or re-ordered, thereby providing additional examples of the present disclosure. It will further be appreciated how, in various examples of the present disclosure, the method of FIG. 7 may be combined with another method disclosed herein, such as that of one of FIGS. 2 to 6.

As indicated at step 701, in this example, the NCR may camp on a first cell and may be in an idle or inactive state (e.g., RRC_Idle or RRC_Inactive). At step 703, when in an idle (or inactive) state, the NCR may perform measurement (e.g., as relating to cell selection) without applying measurement relaxation. For example, the NCR may ignore broadcast measurement parameters from the gNB (i.e., as may be intended for a UE).

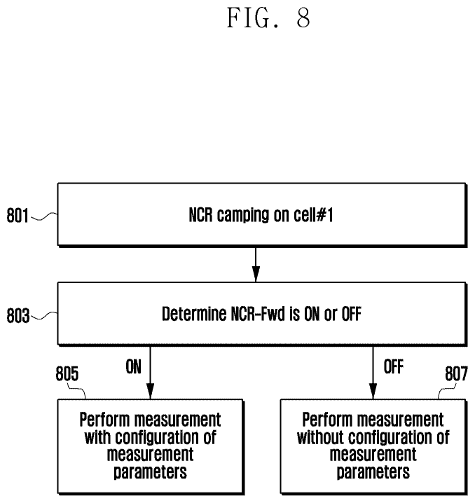

FIG. 8 is a further example of configuring measurement relaxation for a repeater node (e.g. NCR). It will be appreciated that one or more of the operations shown in FIG. 8 may be omitted, replaced and/or re-ordered, thereby providing additional examples of the present disclosure. It will further be appreciated how, in various examples of the present disclosure, the method of FIG. 8 may be combined with another method disclosed herein, such as that of one of FIGS. 2 to 6.

At step 801, in this example, the NCR may camp on a first cell, and may be in either an idle or inactive state (e.g., RRC_Idle or RRC_Inactive). At step 803, the NCR may determine if NCR-Fwd is in an ON state, and may perform measurement (e.g., as relating to cell selection) based on whether the NCR-Fwd is in an OFF or ON state.

In examples, if the NCR-Fwd is determined to be in an ON state at step 803, the NCR may, at step 805, perform said measurements by applying measurement relaxation. For example, the NCR may apply measurement relaxation parameters as received from a broadcast by the gNB. In this example, the NCR may apply measurement relaxation regardless of the signal strength with the gNB.

In another example, if at step 803 NCR-Fwd is determined to be OFF, the NCR may determine, at step 807, to perform measurement without configuration of measurement parameters. In this example, the NCR may determine not to apply (or to ignore) broadcast measurement parameters by a gNB.

Therefore, by configuring measurement relaxation based on a state of NCR-Fwd, it can be provided that unnecessary cell reselection (i.e. without relaxation), is reduced when NCR-Fwd is performing a forwarding operation.

In some cases, when the forwarding function is turned off (e.g., NCR-Fwd turning OFF) following cell reselection to another cell, it may take time for the NCR (e.g., NCR-MT) to acquire information associated with a network entity controlling the other cell. For example, after turning NCR-Fwd OFF, a backhaul link between the NCR and a network entity controlling a cell on which the NCR was previously camped (e.g., when the trigger for performing cell reselection was detected) may be released or disconnected, and an access link between the NCR and a UE may be released or disconnected. This may result in the UE experiencing radio link failure, for example due to a coverage hole. The UE may attempt an RRC re-establishment procedure. This may consume UE and/or network resources to the detriment of the system/entities.

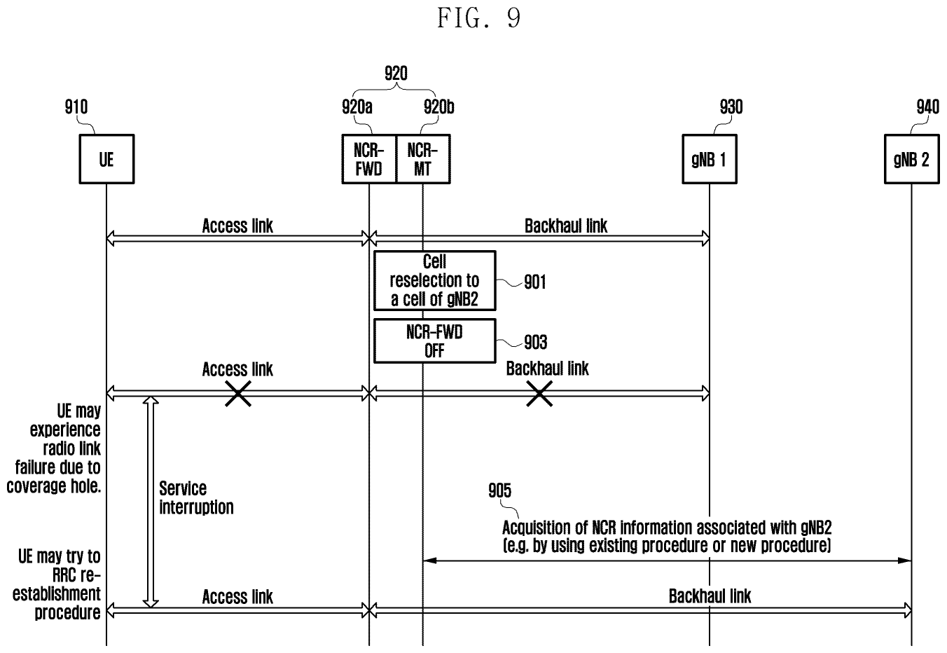

An example of such a situation is illustrated in FIG. 9. Here, an access link is established, or exists, between a UE 910 and NCR-Fwd 920a of NCR 920, and a backhaul link is established, or exists, between NCR-Fwd 920a of NCR 920 and gNB1 930. In 901, NCR 920 performs cell reselection, resulting in a cell of gNB2 940 being selected to camp on. In 903, NCR-Fwd is turned OFF based on the cell reselection (or trigger to perform cell reselection). In some examples, NCR-Fwd being turned off may result in a state in which the NCR 920 (i.e., NCR 920a) is not forwarding any signals to the UE 910.

As a result of NCR-Fwd being turned OFF, the backhaul link is lost (e.g., disconnected or released) and, consequently, the access link is lost. Loss of the access link may result in a service interruption for the UE 910; e.g., the UE 910 may experience radio link failure due to coverage hole.

In 905, the NCR 920 (i.e., NCR-MT 920b) may acquire (e.g., request, receive etc.) configuration information associated with gNB2 940. A backhaul link between gNB2 940 and NCR-Fwd 920b may be established (e.g., based on the configuration information), and an (new) access link between NCR 920 and UE 910 may be established (e.g., based on the configuration information). However, in the interim period, there is the service interruption for the UE 910 due to loss of the backhaul link and resulting loss of the access link, which may reduce satisfaction in the system and/or UE 910 operating efficiency.

Accordingly, one or more examples of the present disclosure, as will be described in the following, provide solutions for mitigating, solving or otherwise addressing this issue. It will be understood that the following examples may be combined with any other examples disclosed herein. For example, any of the following examples may be combined with one of the previous examples by which the NCR modifies a forwarding function, or by which the presence of the NCR (on a cell) is reported, or the presence of the NCR (in a (e.g., NCR specific) tracking area or RAN notification area), or by which measurement relaxation of an NCR is configured. Additionally, the NCR described in any of the following examples may be an NCR as described with reference to FIG. 1. The following examples refer to an NCR but it will be understood that a more general repeater node may be considered instead. Similarly, the following examples refer to gNB(s) but it will be understood that a more general base station, or network entity, may be considered instead.

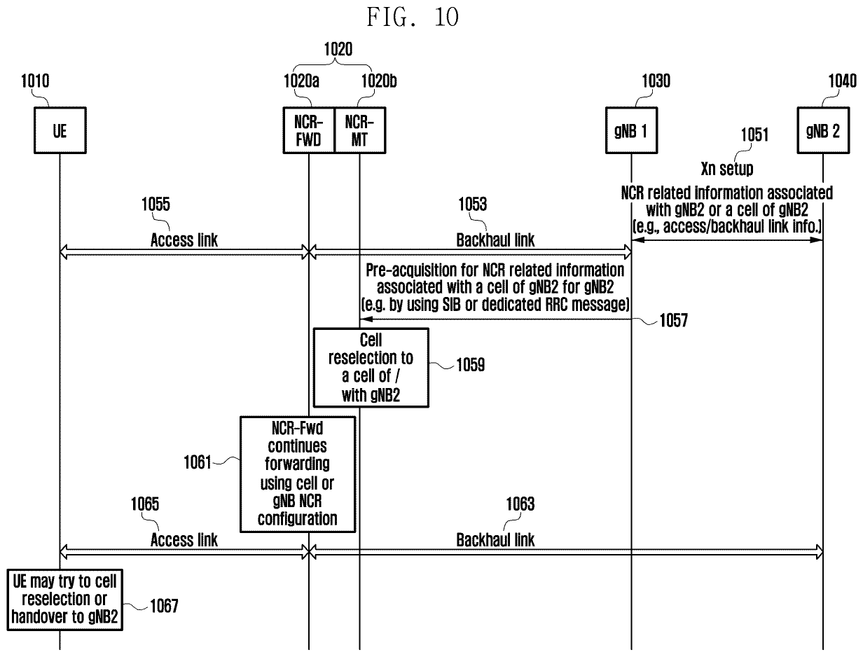

FIG. 10 illustrates, via a flow diagram, a method for modifying a forwarding function of an NCR. According to the method, the forwarding function is not turned off in the sense of the repeater node no longer forwarding signals to the UE, but turned off, or modified, in the sense of the repeater node performing the forwarding function based on different configuration information, which is associated with a cell of a base station (or with the base station) to which the repeater node selects in cell reselection. It will be appreciated that one or more of the operations shown in FIG. 10 may be omitted, replaced and/or re-ordered, thereby providing additional examples of the present disclosure.

In certain examples in accordance with FIG. 10, gNB1 1030 and gNB2 1040 refer to the same gNB. That is, in such examples, even though FIG. 10 represents gNB1 1030 and gNB2 1040 separately, there is actually a single gNB which fulfils the role of gNB1 1030 and gNB2 1040. For instance, such a case may be when the NCR 1020 reselects to another cell controlled by gNB1 1030, when performing cell reselection; in which case, any subsequent operations shown to involve gNB2 1040 can be regarded as instead involving (e.g., being performed by) gNB1 1030.

At 1051, gNB1 1030 and gNB2 1040 communicate such that gNB1 1030 obtains information (e.g., configuration information, NCR related information etc.) associated with gNB2 1040 or associated with a cell controlled by gNB2 1040 (or with one or more cells controlled by gNB2 1040, with the configuration information being cell-specific). For example, the information may comprise access link information and/or backhaul link information.

In some examples, gNB1 1030 obtains the information during Xn setup with gNB2 1040. For example, Xn setup may be performed according to 3GPP TS 38.423 (e.g., Release 17, V17.3.0), where the purpose of Xn setup is indicated as to exchange application level configuration data needed for two NG-RAN nodes to interoperate correctly over the Xn-C interface. In other examples, the information may be updated in a NG-RAN node configuration update; e.g., gNB1 1030 may acquire the information associated with gNB2 1040 or with a cell controlled by gNB2 1040 through NG-RAN node configuration update.

In certain examples, the information associated with gNB2 1040 or with a cell (e.g., the second cell) controlled by gNB2 1040 may be for any type of repeater node (e.g., NCR) that connects to the network (i.e., the network in which gNB1 1030 and gNB2 1040 are provided/included), or may be specific to NCR 1020 deployed in the network.

In various examples of the present disclosure, Xn setup (i.e., operation 1051) is not be performed or is optionally performed. That is, the Xn setup operation may not be performed in all examples of the present disclosure and may be omitted.

For example, in a case where the NCR 1020 reselects to a different cell of the same gNB (e.g., to another cell of gNB1 1030), it will be appreciated that Xn setup is not required for the NCR 1020 to acquire (e.g., pre-acquire) configuration information for the different cell—the gNB (that the NCR already camps on a cell of; e.g., gNB1 1030) may provide configuration information (e.g., cell-specific configuration information) for the different cell in advance without needing to acquire the configuration information.

As shown in FIG. 10, backhaul link 1053 exists, or is connected, between gNB1 1030 and NCR 1020 (i.e., NCR-Fwd 1020a). For example, NCR 1020 may be camping on a cell (e.g., a first cell) controlled by gNB1 1030. Additionally, access link 1055 exists, or is connected, between NCR 1020 (i.e., NCR-Fwd 1020a) and UE 1010. For example, the NCR 1020 may be forwarding transmissions on the first cell to the UE 1010 using the access link 1055.

At 1057, the NCR 1020 (e.g., NCR-MT 1020b) acquires configuration information (e.g., repeater information, NCR-related information) associated with gNB2 1040 or with a cell controlled by gNB2 1040 (e.g., by using SIB or a dedicated RRC message). In various examples where operation 1051 is performed, the configuration information may be the same as, or include at least part of, the information obtained by gNB1 1030 from gNB2 1040 at 1051.

This may be regarded as the NCR 1020 acquiring the configuration information before cell reselection. For example, upon detecting the trigger for cell reselection, the NCR 1020 may acquire the configuration information from gNB1 1030; for example, the NCR 1020 may request the configuration information from gNB1 1030. In another example, gNB1 1030 may provide NCR 1020 with the configuration information, e.g., in view of having previously obtained the information or otherwise storing the information (such as via operation 1051); such that the NCR 1020 may have the configuration information in the event of cell reselection being triggered. In some examples, the configuration information may include configuration information associated with one or more cells controlled by the second gNB 1040, with cell-specific configuration information being provided for each. Accordingly, in the event that the NCR 1020 reselects to one of these one or more cells, the NCR 1020 already has the configuration information for the selected cell.

As indicated above, in some cases the NCR 1020 may reselect to another cell of the first gNB 1030. For instance, the NCR 1020 may (only) be in the coverage of a number of cells controlled by the first gNB 1030, such that cell reselection will result in the NCR 1020 camping on a cell (e.g., another cell) controlled by the first gNB 1030. In such a case, in the method of FIG. 10 it may be considered that gNB1 1030 and gNB2 1040 are one gNB performing all the operations shown for gNB1 1030 and gNB2 1040, with operation 1051 omitted as no Xn setup is required. This one gNB may provide NCR 1020 with configuration information associated with one or more cells of the gNB, prior to cell reselection being performed.

In certain examples, the acquired configuration information is stored for a configured (e.g., predetermined or specified) amount of time. The NCR 1020 may therefore implement a timer for each stored configuration information (which may be started when the configuration information is acquired or stored, when the configuration information is used last, or when a forwarding function based on the configuration information is turned OFF or modified). Upon expiration of a timer for a corresponding stored configuration information, the NCR 1020 may delete the corresponding stored configuration information. Alternatively, the NCR 1020 may move the stored configuration information to another memory, such as a long-term storage, on expiration of a corresponding timer. For instance, the configured amount of time might be specific to each configuration information or specific to a cell for which configuration information is stored. In another example, the NCR 1020 may implement a global timer, upon expiration of which all stored configuration information, that is not in use (e.g., that is not related to a forwarding function being performed, or to a cell or network entity for which forwarding is being performed), is deleted. In other examples, the amount of time for which configuration information associated with a gNB or cell is stored (also referred to as a validity duration) is hardcoded.

At 1059, NCR 1020 (i.e., NCR-MT 1020b) performs cell reselection, e.g., following detection of a trigger for performing cell reselection (such as, for example, one of the triggers that have been described previously herein). The NCR 1020 selects a cell (e.g., a second cell) controlled by gNB2 1040 during cell reselection. The configuration information may comprise configuration(s) associated with the second cell or gNB2 1040, such as to allow the NCR 1020 to perform a forwarding function for transmissions on the second cell.

At 1061, the NCR 1020 (i.e., NCR-Fwd 1020a) continues forwarding to UE 1010 based on the configuration information associated with gNB2 1040 or with the cell (i.e., the second cell) controlled by gNB2 1040. For example, the NCR 1020 performs the forwarding function using the configuration information. Backhaul link 1063 is connected between NCR-Fwd 1020a and gNB2 1040. In some examples, backhaul link 1063 may be regarded as a continuation of backhaul link 1053 (e.g., such as in a case when gNB2 1040 is gNB1 1030, with cell reselection resulting in NCR 1020 camping on a different cell of gNB1 1030) or as an entirely new backhaul link. Access link 1065 is connected between NCR-Fwd 1020a and UE 1010. In some examples, access link 1065 may be regarded as a continuation of access link 1055 or as an entirely new access link. In various examples, both forwarding configuration and backhauling configuration (e.g., backhaul link) are resumed (or re-activated) following cell reselection. In other examples, only forwarding configuration is resumed (or re-activated) following cell reselection; e.g., backhauling is not configured.

As a result, it may be considered that the forwarding function is performed seamlessly (or substantially so) across the cell reselection procedure. That is, UE 1010 does not experience (or experiences reduced) service interruption or radio link failure as a result of NCR 1020 having pre-acquired the configuration information associated with gNB2 1040 or the configuration information associated with the second cell, meaning the forwarding function may continue to be performed after the NCR 1020 camps on the second cell.

At 1067, the UE 1010 may perform cell reselection or handover to gNB2 1040. This operation may follow from access link 1065 being established. For example: if the UE 1010 is in idle or inactive mode (RRC idle or RRC inactive), the UE 1010 may perform cell reselection; if the UE 1010 is in connected mode (RRC connected), the UE 1010 may perform re-establishment; or the UE 1010 may handed over by gNB1 1030 to gNB2 1040 (e.g., in cases where the second cell is controlled by gNB2 1040 different to gNB1 1030).

In FIG. 10, according to certain examples, gNB1 1030 may use knowledge of the surrounding environment to deliver, to the NCR, the configuration information to be used for other donor gNBs (e.g., other gNBs on which the NCR 1020 may camp). In FIG. 10, this is reflected by 1051 and 1057. In an alternative, NCR-MT 1020b may acquire the configuration information associated with gNB2 1040 via SIB of gNB2 1040. In other words, in certain examples, 1051 and 1057 may not be performed, and instead the NCR 1020 obtains the configuration information associated with gNB2 1040 via SIB of gNB2 1040 (e.g., in a received system broadcast information message). The NCR 1020 may store the acquired configuration information for use when, or if, the NCR 1020 selects to camp on a cell controlled by gNB2 1040.

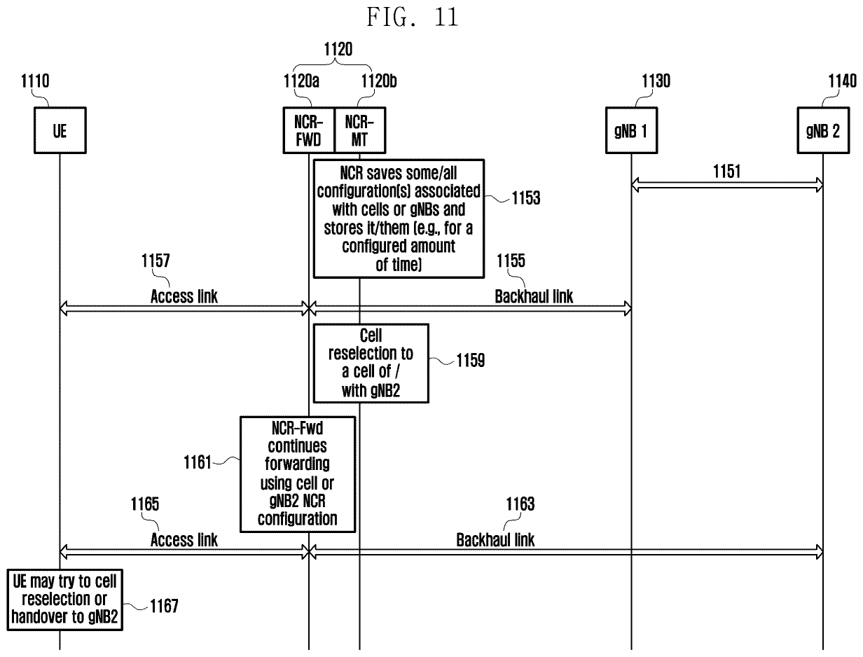

FIG. 11 illustrates, via a flow diagram, a method for modifying a forwarding function of a repeater node (e.g., an NCR, as will be referred to in the method). FIG. 11 may be seen to describe an alternative method to that provided in FIG. 10, but it will be appreciated that a NCR (or other described entity) may be configured to perform both the method of FIG. 10 and the method of FIG. 11 (e.g., in different situations, or depending on the capabilities of other entities involved in the methods). According to the method, the forwarding function is not turned off in the sense of the repeater node no longer forwarding signals to the UE, but turned off, or modified, in the sense of the repeater node performing the forwarding function based on different configuration information, which is associated with a cell of a base station (or with the base station) to which the repeater node selects in cell reselection. It will be appreciated that one or more of the operations shown in FIG. 11 may be omitted, replaced and/or re-ordered, thereby providing additional examples of the present disclosure.

In certain examples in accordance with FIG. 11, gNB1 1130 and gNB2 1140 refer to the same gNB. That is, in such examples, even though FIG. 11 represents gNB1 1130 and gNB2 1140 separately, there is actually a single gNB which fulfils the role of gNB1 1130 and gNB2 1140. For instance, such a case may be when the NCR 1120 reselects to another cell controlled by gNB1 1130, when performing cell reselection; in which case, any subsequent operations shown to involve gNB2 1140 can be regarded as instead involving (e.g., being performed by) gNB1 1130.

At 1151, optionally, communication between gNB1 1030 and gNB2 1040 may occur, as in operation 1051 of FIG. 10. For example, Xn setup may be performed in 1151. However, as indicated above, this operation may be omitted.

At 1153, NCR 1120 (e.g., NCR-MT 1120b) saves or stores one or more (e.g., all) configuration information (e.g., repeater information, NCR-related information etc.) associated with one or more network entities (each network entity controlling one or more cells, for example) or associated with one or more cells (e.g., cell specific configuration information). For example, the NCR 1120 may store first configuration information associated with gNB1 1130 or associated with a cell controlled by gNB1 1130, and second configuration information associated with gNB2 1140 or associated with a cell controlled by gNB2 1140. In certain examples, gNB1 1130 and gNB2 1140 are the same gNB (e.g., one gNB controls a number of cells on which NCR 1120 may camp, and cell-specific configuration information is stored by NCR 1120 for one or more cells of the gNB). In other examples, gNB1 1130 and gNB2 1140 are different base stations. In each case, the stored configuration information may be used in performing a forwarding function for a cell (i.e., transmissions on a cell) controlled by the respective base station.

In certain examples, the configuration information is stored following the NCR 1120 having previously performed a forwarding function based on the configuration information. For instance: the NCR 1120 camped on a first cell controlled by gNB1 1130, forwarded transmissions on the first cell to UE 1110 based on the first configuration information (e.g., associated with the first cell or with gNB1 1130), performed cell reselection and camped on a second cell controlled by gNB2, but stored the first configuration information in spite of no longer camping on the first cell. In other words, the NCR 1120 stores ‘old’ NCR configurations when having been connected to corresponding gNBs. In other examples, the NCR 1120 is provided with configuration information associated with one or more network entities or cells (e.g., by gNB1 1120 when camping on a cell controlled by gNB1 1120), including network entity/entities controlling a cell(s) on which the NCR 1120 has not previously camped or performed forwarding on or cell(s) on which the NCR 1120 has not previously camped on or performed forwarding on.

In certain examples, the stored configuration information is stored for a configured (e.g., predetermined or specified) amount of time. The NCR 1120 may therefore implement a timer for each stored configuration information (which may be started when the configuration information is stored, when the configuration information is used last, or when a forwarding function based on the configuration information is turned OFF or modified). Upon expiration of a timer for a corresponding stored configuration information, the NCR 1120 may delete the corresponding stored configuration information. Alternatively, the NCR 1120 may move the stored configuration information to another memory, such as a long-term storage, on expiration of a corresponding timer. For instance, the configured amount of time might be specific to each configuration information or specific to a cell for which configuration information is stored. In another example, the NCR 1120 may implement a global timer, upon expiration of which all stored configuration information, that is not in use (e.g., that is not related to a forwarding function being performed, or to a cell or network entity for which forwarding is being performed), is deleted. In other examples, the amount of time for which configuration information associated with a gNB is stored (also referred to as a validity duration) is hardcoded.

In some examples, a predetermined amount of time to be stored (or validity duration) may be configured for each configuration information (e.g., cell-specific, or gNB specific). In other examples, the same validity duration may be applied/used for two or more stored configuration information.

In FIG. 11, backhaul link 1155 and access link 1157 are illustrated. These links may be connected prior to, during or after operation 1153. That is, the NCR 1120 may be camping on the first cell while operation 1153 is performed, e.g., in which case the configuration information associated with gNB1 or with the first cell is stored. Alternatively, the NCR 1120 may be camping on a cell controlled by another gNB (not shown) when operation 1153 is performed, and then performs cell reselection and camps on the first cell later; e.g., in which case the configuration information associated with the other gNB (or the cell controlled by such) is stored.

At 1159, NCR 1120 (i.e., NCR-MT 1120b) performs cell reselection, e.g., following detection of a trigger for performing cell reselection. The NCR 1120 selects a cell (e.g., a second cell) controlled by gNB2 1140 during cell reselection. In certain examples, the NCR 1120 may obtain configuration information associated with gNB2 1140 or with the cell controlled by gNB2 1140 (i.e., the second cell) from among the stored configuration information. The configuration information may comprise configuration(s) associated with the second cell or with gNB2 1140, such as to allow the NCR 1120 to perform a forwarding function for transmissions on the second cell. According to certain examples, the NCR 1120 selects the second cell on the basis of having configuration information associated with gNB2 1140 or with the second cell stored at the NCR 1120. That is, an additional factor taken into account in cell reselection is whether or not, for a given cell, the NCR 1120 stores configuration information associated with a network entity controlling said cell or configuration information associated with said cell.

At 1161, the NCR 1120 (i.e., NCR-Fwd 1120a) continues forwarding to UE 1110 based on the configuration information. For example, the NCR 1120 performs the forwarding function using the configuration information that the NCR 1120 has stored after previously camping on the second cell. Backhaul link 1163 is established/connected between NCR-Fwd 1120a and gNB2 1140. In some examples, backhaul link 1163 may be regarded as a continuation of backhaul link 1155 (e.g., such as in a case when gNB2 1140 is gNB1 1130, with cell reselection resulting in NCR 1120 camping on a different cell of gNB1 1130) or as an entirely new backhaul link. Access link 1165 is established/connected between NCR-Fwd 1120a and UE 1110. In some examples, access link 1165 may be regarded as a continuation of access link 1157 or as an entirely new access link. In various examples, both forwarding configuration and backhauling configuration (e.g., backhaul link) are resumed (or re-activated) following cell reselection. In other examples, only forwarding configuration is resumed (or reactivated) following cell reselection; e.g., backhauling is not configured.

As a result, it may be considered that the forwarding function is performed seamlessly (or substantially so) across the cell reselection procedure. That is, UE 1110 does not experience service interruption or radio link failure as a result of NCR 1120 having stored the configuration information associated with gNB2 1140 after having previously camped on, and/or performed forwarding on, a cell controlled by gNB2 1140, meaning the forwarding function may continue to be performed after the NCR 1120 camps on the second cell.

At 1167, the UE 1110 may perform cell reselection or handover to gNB2 1140. This operation may follow from access link 1165 being established. For example: if the UE 1110 is in idle or inactive mode (RRC idle or RRC inactive), the UE 1110 may perform cell reselection; if the UE 1110 is in connected mode (RRC connected), the UE 1110 may perform re-establishment; or the UE 1110 may handed over by gNB1 1130 to gNB2 1140 (e.g., in cases where the second cell is controlled by gNB2 1140 different to gNB1 1130).

In various examples according to the method of FIG. 11, NCR-MT 1120b uses old NCR configuration(s) when reselecting to a cell of a corresponding base station. A benefit of this approach is that, in some cases, a repeater node will only be in between a smaller number of base stations. That is, an NCR may only connect with a small number of gNBs and so storing configuration information associated with these gNBs, for use in the event of camping on a corresponding cell, is practical.

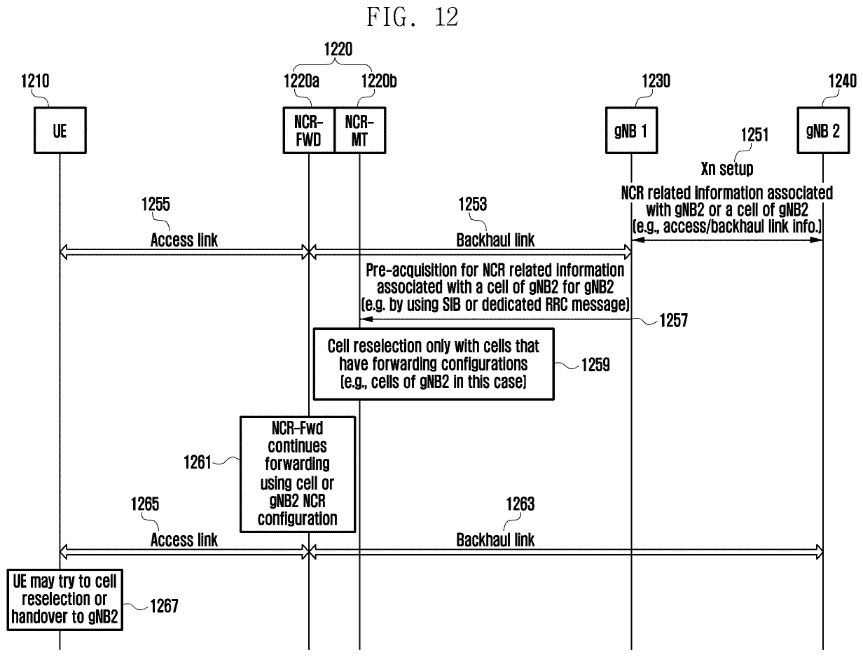

FIG. 12 illustrates, via a flow diagram, a method for modifying a forwarding function of a NCR. FIG. 12 may be seen to describe an alternative method to that provided in FIG. 10 and/or FIG. 11, but it will be appreciated that a NCR (or other described entity) may be configured to perform the method of either/both of FIG. 10 and FIG. 11 and the method of FIG. 12 (e.g., in different situations, or depending on the capabilities of other entities involved in the methods). According to the method, the forwarding function is not turned off in the sense of the repeater node no longer forwarding signals to the UE, but turned off, or modified, in the sense of the repeater node performing the forwarding function based on different configuration information, which is associated with a cell of a base station (or with the base station) to which the repeater node selects in cell reselection. It will be appreciated that one or more of the operations shown in FIG. 12 may be omitted, replaced and/or re-ordered, thereby providing additional examples of the present disclosure.

In certain examples in accordance with FIG. 12, gNB1 1230 and gNB2 1240 refer to the same gNB. That is, in such examples, even though FIG. 12 represents gNB1 1230 and gNB2 1240 separately, there is actually a single gNB which fulfils the role of gNB1 1230 and gNB2 1240. For instance, such a case may be when the NCR 1220 reselects to another cell controlled by gNB1 1230, when performing cell reselection; in which case, any subsequent operations shown to involve gNB2 1240 can be regarded as instead involving (e.g., being performed by) gNB1 1230.

At 1251, gNB1 1230 and gNB2 1240 communicate such that gNB1 1230 obtains information (e.g., NCR related information) associated with gNB2 1240 or associated with a cell(s) controlled by gNB2 1240 (e.g., cell specific information). For example, the information may comprise access link information and/or backhaul link information). This operation may be performed similar to operation 1051 described above in relation to FIG. 10 (i.e., according to any of the examples described in combination with 1051).

For example, gNB1 1230 may obtain the information during Xn setup with gNB2 1240, or the information may be updated in a NG-RAN node configuration update. In certain examples, the information associated with gNB2 1240 or with a cell(s) controlled by gNB2 1240 may be for any type of repeater node (e.g., NCR) that connects to the network (i.e., the network in which gNB1 1230 and gNB2 1240 are provided/included), or may be specific to NCR 1220 deployed in the network.

Operation 1251 may be omitted or regarded as optional, as discussed for operation 1051 of FIG. 10. In particular, if gNB2 1240 is gNB1 1230 in the sense that cell reselection results in NCR 1220 camping on another cell of gNB1 1230 (or even the same cell as previously camped on), then gNB1 1230 may already have information associated with the cells it controls.

As shown in FIG. 12, backhaul link 1253 exists, or is connected, between gNB1 1230 and NCR 1220 (i.e., NCR-Fwd 1220a). For example, NCR 1220 may be camping on a cell (e.g., a first cell) controlled by gNB1 1230. Additionally, access link 1255 exists, or is connected, between NCR 1220 (i.e., NCR-Fwd 1220a) and UE 1210. For example, the NCR 1220 may be forwarding transmission on the first cell to the UE 1210 using the access link 1255.

At 1257, NCR 1220 acquires (e.g., ‘pre-acquires’) configuration information (e.g., repeater information, NCR-related information etc.) associated with gNB2 1240 or associated with a cell(s) controlled by gNB2 1240. This configuration information may be included among configuration information for a plurality of network entities or cells acquired from gNB1 1230 (e.g., via SIB or RRC message); that is, gNB1 1230 may provide NCR 1220 with configuration information on a number of gNBs including gNB2 1240 and/or on a number of cells controlled by other gNBs including gNB2 1240 (or including a cell controlled by gNB2 1240).

In certain examples, the acquired configuration information is stored for a configured (e.g., predetermined or specified) amount of time. The NCR 1220 may therefore implement a timer for each stored configuration information (which may be started when the configuration information is acquired or stored, when the configuration information is used last, or when a forwarding function based on the configuration information is turned OFF or modified). Upon expiration of a timer for a corresponding stored configuration information, the NCR 1220 may delete the corresponding stored configuration information. Alternatively, the NCR 1220 may move the stored configuration information to another memory, such as a long-term storage, on expiration of a corresponding timer. For instance, the configured amount of time might be specific to each configuration information, specific to a cell for which configuration information is stored, or specific to a gNB for which configuration information is stored. In another example, the NCR 1220 may implement a global timer, upon expiration of which all stored configuration information, that is not in use (e.g., that is not related to a forwarding function being performed, or to a cell or network entity for which forwarding is being performed), is deleted. In other examples, the amount of time for which configuration information associated with a gNB or cell is stored (also referred to as a validity duration) is hardcoded.

At 1259, NCR 1220 performs cell reselection, e.g., following detecting a trigger to perform cell reselection (examples of which are disclosed herein). Here, NCR-MT 1220b is configured to perform cell reselection with the gNBs or cells for which configuration information has been provided in advance. In other words, if NCR-MT 1220b acquired, at 1257, configuration information associated with a plurality of gNBs and/or a plurality of cells, then in operation 1259 NCR-MT 1220b will perform cell reselection only with this plurality of gNBs and/or a plurality of cells. For example, NCR-MT 1220b will only select, as a cell to camp on, a cell controlled by one of the plurality of gNBs or a cell from among the plurality of cells, and will not select a cell controlled by a gNB for which configuration information has not been provided. The gNB2 1240 may be regarded as the gNB controlling the cell (i.e., the second cell) which the NCR 1220 determines to camp on, for the sake of the description of FIG. 12.

In an alternative formulation, when performing cell reselection, NCR 1220 may not consider a cell for reselection if the NCR does not have configuration information (e.g., valid configuration information) for the cell. For example, during cell reselection, NCR 1220 may identify one or more cells, determine whether configuration information is not stored/known for any of the one or more cells, and not consider cells for which configuration information is not stored/known for reselection.

At 1261, the NCR 1220 (i.e., NCR-Fwd 1220a) continues forwarding to UE 1210 based on the configuration information associated with gNB2 1240 or associated with the second cell. For example, the NCR 1220 performs the forwarding function using the configuration information. Backhaul link 1263 is established/connected between NCR-Fwd 1220a and gNB2 1240. In some examples, backhaul link 1263 may be regarded as a continuation of backhaul link 1253 (e.g., such as in a case when gNB2 1240 is gNB1 1230, with cell reselection resulting in NCR 1220 camping on a different cell of gNB1 1230) or as an entirely new backhaul link. Access link 1265 is established/connected between NCR-Fwd 1220a and UE 1210. In some examples, access link 1265 may be regarded as a continuation of access link 1255 or as an entirely new access link. In various examples, both forwarding configuration and backhauling configuration (e.g., backhaul link) are resumed (or re-activated) following cell reselection. In other examples, only forwarding configuration is resumed (or reactivated) following cell reselection; e.g., backhauling is not configured.

As a result, it may be considered that the forwarding function is performed seamlessly (or substantially so) across the cell reselection procedure. That is, UE 1210 does not experience service interruption or radio link failure as a result of NCR 1220 having pre-acquired the configuration information associated with gNB2 1240 or with the second cell amongst the configuration information associated with the one or more gNBs or cells obtained from gNB1 1230, meaning the forwarding function may continue to be performed after the NCR 1220 camps on the second cell.

At 1267, the UE 1210 may perform cell reselection or handover to gNB2 1240. This operation may follow from access link 1265 being established. For example: if the UE 1210 is in idle or inactive mode (RRC idle or RRC inactive), the UE 1210 may perform cell reselection; if the UE 1210 is in connected mode (RRC connected), the UE 1210 may perform re-establishment; or the UE 1210 may handed over by gNB1 1230 to gNB2 1240 (e.g., in cases where the second cell is controlled by gNB2 1240 different to gNB1 1230).

In various examples according to FIG. 12, the NCT-MT 1220b is only configured to perform cell reselection with gNBs and/or cells where the configuration information (e.g., NCR related configuration) has been provided by advance (e.g., by a gNB controlling a cell on which NCR 1220 is camped or by other means). This may be advantageous in cases where there are a lot of mobility events. If there are mobile cells that are NCR-capable, then a network may want to ensure that mobility is only performed with cells where there have already been an establishment or provision of NCR configurations.

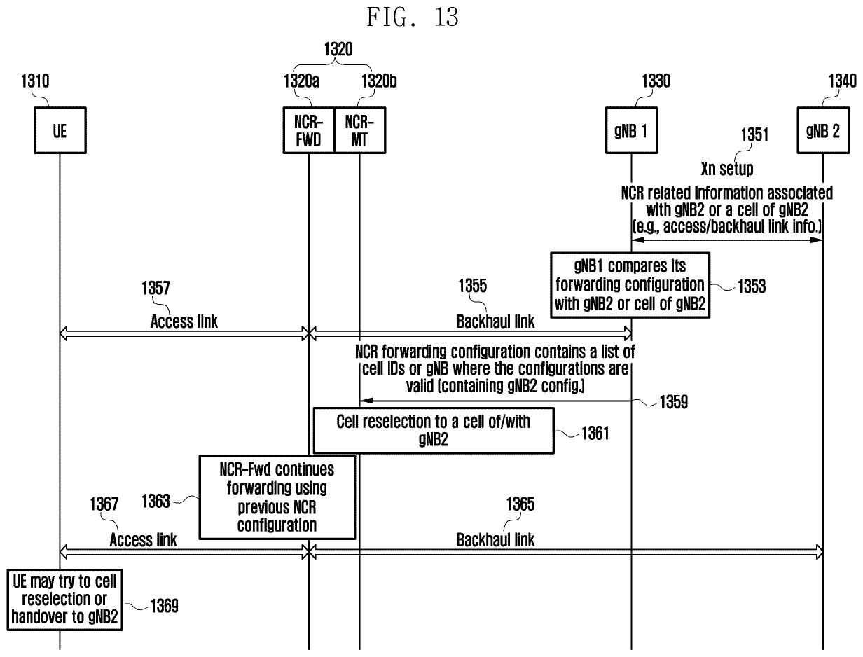

FIG. 13 illustrates, via a flow diagram, a method for modifying a forwarding function of a repeater node (e.g., an NCR, as will be referred to in the method). FIG. 13 may be seen to describe an alternative method to that provided in FIG. 10, FIG. 11 and/or FIG. 12, but it will be appreciated that a NCR (or other described entity) may be configured to perform the method of one or more of FIG. 10, FIG. 11 and FIG. 12 and the method of FIG. 13 (e.g., in different situations, or depending on the capabilities of other entities involved in the methods). According to the method, the forwarding function is not turned off in the sense of the repeater node no longer forwarding signals to the UE, but rather turned off in another sense, such as being modified to forward signal for another gNB and/or on another cell using the same configuration information as used for forwarding previously. It will be appreciated that one or more of the operations shown in FIG. 13 may be omitted, replaced and/or re-ordered, thereby providing additional examples of the present disclosure.

In certain examples in accordance with FIG. 13, gNB1 1330 and gNB2 1340 refer to the same gNB. That is, in such examples, even though FIG. 13 represents gNB1 1330 and gNB2 1340 separately, there is actually a single gNB which fulfils the role of gNB1 1330 and gNB2 1340. For instance, such a case may be when the NCR 1320 reselects to another cell controlled by gNB1 1330, when performing cell reselection; in which case, any subsequent operations shown to involve gNB2 1340 can be regarded as instead involving (e.g., being performed by) gNB1 1330.

At 1351, a first network entity (e.g., gNB1 1330, as will be referred to hereafter) and a second network entity (e.g., gNB2 1340, as will be referred to hereafter) communicate such that gNB1 1330 obtains information (e.g., NCR related information) associated with gNB2 1340 or with a cell(s) controlled by gNB2 1340 (e.g., cell-specific information). For example, the information may comprise access link information and/or backhaul link information). This operation may be performed according to 1051 described above in relation to FIG. 10 (i.e., according to any of the examples described in combination with 1051).

For example, gNB1 1330 may obtain the information during Xn setup with gNB2 1340, or the information may be updated in a NG-RAN node configuration update. In certain examples, the information associated with gNB2 1340 or a cell(s) controlled by gNB2 1340 may be for any type of repeater node (e.g., NCR) that connects to the network (i.e., the network in which gNB1 1330 and gNB2 1340 are provided/included), or may be specific to NCR 1320 deployed in the network.

Operation 1351 may be omitted or regarded as optional, as discussed for operation 1051 of FIG. 10. In particular, if gNB2 1340 is gNB1 1330 in the sense that cell reselection results in NCR 1320 camping on another cell of gNB1 1330 (or even the same cell as previously camped on), then gNB1 1330 may already have information associated with the cells it controls.

At 1353, gNB1 1330 may identify configuration information associated with another gNB(s) or a cell(s) controlled by another gNB(s) (e.g., cell specific configuration information) which match specific configuration information, such as current configuration information for NCR 1320 (e.g., configuration information currently being used by NCR 1320 to perform forwarding on a cell (e.g. first cell) controlled by gNB1 1330). For example, gNB1 1330 may acquire configuration information associated with one or more other gNBs, including gNB2 1340, or associated with one or more other cells, including a cell controlled by gNB2 1340, and compare the acquired configuration information to the specific configuration information, e.g., configuration information associated with gNB1 1330 or with the first cell controlled by gNB1 1330. The gNB1 1330 may then identify the/any gNBs or cells which are associated with matching configuration information (e.g., configuration information matching the specific configuration information). In a case where gNB1 1330 controls a plurality of cells, gNB1 1330 may not acquire configuration information from another gNB(s) or associated with cell(s) of other gNB(s), but may instead identify one or more other cells it controls (i.e., cell(s) controlled by gNB1 1330 excluding the first cell) which match the configuration information associated with the first cell.

As shown in FIG. 12, backhaul link 1355 exists, or is established, between gNB1 1330 and NCR 1320 (i.e., NCR-Fwd 1320a). For example, NCR 1320 may be camping on a cell (e.g., the first cell) controlled by gNB1 1330. Additionally, access link 1357 exists, or is established, between NCR 1320 (i.e., NCR-Fwd 1320a) and UE 1310. For example, the NCR 1320 may be forwarding transmission on the first cell to the UE 1310 using the access link 1357. It will be appreciated that backhaul link 1355 and/or access link 1357 may be connected in any chronological order around (i.e., before, during, after) operations 1351 and 1353.

At 1359, NCR 1320 (i.e., NCR-MT 1320b) may receive or obtain, from gNB1 1330, an indication of one or more other gNBs, including gNB2 1340, and/or an indication of one or more cells which are associated with the specific configuration information (e.g., the current configuration information). For example, gNB1 1330 may transmit a list of the one or more other gNBs and/or of the one or more cells to the NCR 1320. Such a list may include cell identities/identifiers or gNB identities/identifiers, as appropriate.

At 1361, NCR 1320 (i.e., NCR-MT 1320b) performs cell reselection, e.g., following detecting a trigger to perform cell reselection (examples of which are disclosed herein). Here, NCR-MT 1320b is configured to perform cell reselection with the gNBs or cells among the indicated one or more other gNBs or cells. In other words, NCR-MT 1320b will select a cell which is controlled by a gNB or cell associated with the specific configuration information, which may be current configuration information such as used by the NCR 1320 in performing forwarding when the trigger for performing cell reselection was detecting (e.g., the configuration information associated with gNB1 1330 or with the first cell). The gNB controlling the selected cell may be regarded as gNB2 1340 with the selected cell being the second cell, for the sake of the description of FIG. 13.

In an alternative formulation, when performing cell reselection, NCR 1320 may not consider a cell for reselection if configuration information associated with the cell (or associated with a network entity controlling the cell) does not match the specific configuration information (e.g., the configuration information associated with the first cell). For example, during cell reselection, NCR 1320 may identify one or more cells, determine whether configuration information associated with any of the one or more cells matches the specific configuration information, and not consider cells for which configuration information does not match the specific configuration information.

At 1363, the NCR 1320 (i.e., NCR-Fwd 1320a) continues forwarding to UE 1310 based on the previous configuration information (i.e., the specific configuration information), which may be the configuration information associated with gNB1 1330 or with the first cell. For example, after cell reselection, the NCR 1320 performs the forwarding function using the same configuration information as before the cell reselection. Backhaul link 1365 is established/connected between NCR-Fwd 1320a and gNB2 1340. In some examples, backhaul link 1365 may be regarded as a continuation of backhaul link 1355 (e.g., such as in a case when gNB2 1340 is gNB1 1330, with cell reselection resulting in NCR 1320 camping on a different cell of gNB1 1330) or as an entirely new backhaul link. Access link 1367 is established/connected between NCR-Fwd 1320a and UE 1310. In some examples, access link 1367 may be regarded as a continuation of access link 1357 or as an entirely new access link. In various examples, both forwarding configuration and backhauling configuration (e.g., backhaul link) are resumed (or re-activated) following cell reselection. In other examples, only forwarding configuration is resumed (or re-activated) following cell reselection; e.g., backhauling is not configured

As a result, it may be considered that the forwarding function is performed seamlessly (or substantially so) across the cell reselection procedure. That is, UE 1310 does not experience service interruption or radio link failure as a result of NCR 1320 having selected a cell to camp on which is controlled by a gNB associated with the configuration information which matches previous configuration information, meaning the forwarding function may continue to be performed after the NCR 1320 camps on the second cell.

At 1369, the UE 1310 may perform cell reselection or handover to gNB2 1340. This operation may follow from access link 1367 being established. For example: if the UE 1310 is in idle or inactive mode (RRC idle or RRC inactive), the UE 1310 may perform cell reselection; if the UE 1310 is in connected mode (RRC connected), the UE 1310 may perform re-establishment; or the UE 1310 may handed over by gNB1 1330 to gNB2 1340 (e.g., in cases where the second cell is controlled by gNB2 1340 different to gNB1 1330).

In various examples according to the method of FIG. 13, the NCR 1320 is configured with an NCR configuration which includes information on which cells/gNBs the NCR configuration can be used on. The gNB1 1330 may receive NCR configurations of other gNBs and compare them to a current planned NCR configuration for the NCR 1320. If a received NCR configuration is the same as the current planned NCR configuration, it may be included in a list which is signalled gNB1 1330, where the list includes cell/gNBs where the NCR configuration will be the same. As such, after cell reselection to gNB2 1340, the NCR-Fwd 1320a does not turn OFF but continues forwarding using the same NCR configuration as when connected to gNB1 1330.

Examples in accordance with the methods of each or any of FIGS. 10 to 13 include cases where the second cell is the first cell, i.e., where cell reselection results in the NCR camping on the same cell as the NCR was camping on prior to performing cell reselection (e.g., when the trigger was detected). In such cases, the second gNB2 is the first gNB1. Of course, other examples in accordance with the methods of each of FIGS. 10 to 13 include cases where the second cell is different to the first cell (e.g., the second cell is controlled by a different base station to the first cell, or is a different cell controlled by the same base station), and cases where gNB2 is different to gNB1 (e.g., the second cell is controlled by a different base station to the first cell).

Additionally, although each of FIGS. 10 to 13 show gNB1 and gNB2 (with the option of these being the same gNB, as discussed above), it will be appreciated that examples in accordance with the methods of each or any of these figures may include additional base stations (e.g., gNB3, gNB4, . . . etc.). This may be the case if the NCR is in the coverage of a cell controlled by such an additional base station, in which case the method may consider the additional base station(s) in a similar manner to gNB2 (where, implicitly, the additional base station(s) are not gNB1).

Examples in accordance with the methods of each or any of FIGS. 10 to 13, and/or with the method(s) of any disclosure herein, may further include the condition that, when performing cell reselection, the NCR does not consider any found acceptable cell(s) (e.g., for reselection), or does not camp on an/any acceptable cell. For example, after detecting a trigger for performing cell reselection, NCR-Fwd is modified (e.g., turned OFF) and, if only acceptable cell(s) are found during cell reselection, NCR-Fwd remains modified (e.g., turned OFF), where NCR does not determine to camp on an acceptable cell. In a further example, NCR-Fwd may be modified further (e.g., turned ON) when a suitable cell is identified, in a subsequent cell reselection.

There now follow a series of numbered examples.

According to a first example of the present disclosure, there is provided a method, of a repeater node configured to perform a forwarding function in a network, the method comprising: when camping on a first cell of the network, detecting a trigger for performing cell reselection; in response to a second cell being selected during the cell reselection, camping on the second cell, and modifying the forwarding function.

According to a second example of the present disclosure, there is provided the method of the first example, further comprising: when performing the cell reselection, identifying, based on at least one cell selection criterion, the second cell to not be a suitable cell based on at least one cell selection criterion.

According to a third example of the present disclosure, there is provided the method of the first or second example, wherein the detected trigger is a trigger for performing a network re-selection, and wherein the second cell is located in a second network different to the network of the first cell.

According to a fourth example of the present disclosure, there is provided the method of the first or second example, wherein the detected trigger is a trigger for performing a network re-selection, and the method further comprises: receiving a signal rejecting a selected network during the network re-selection.

According to a fifth example of the present disclosure, there is provided the method of the first or second example, wherein the detected trigger is a trigger for performing a network re-selection, and the method further comprises: receiving a signal accepting a selected network during the network re-selection.

According to a sixth example of the present disclosure, there is provided the method of any one of the first example to the fifth example, wherein modifying the forwarding function comprises changing the forwarding function from an on state to an off state.

According to a seventh example of the present disclosure, there is provided the method of the sixth example, wherein the off state comprises: preventing a state in which the repeater node forwards data; or forwarding configuration of the repeater node is discarded; and/or a default forwarding configuration is applied.

According to an eighth example of the present disclosure, there is provided the method of the sixth or seventh example, wherein the on state comprises one of: performing the forwarding function for all signals; performing the forwarding function selected signals; performing the forwarding function for specific transmissions received from a network entity controlling the first cell; and performing the forwarding function on specific transmissions by the repeater node.

According to a ninth example of the present disclosure, there is provided the method of any one of the first example to the sixth example, further comprising, while camping on the first cell, performing forwarding based on first configuration information associated with a network entity controlling the first cell or associated with the first cell; wherein modifying the forwarding function comprises performing forwarding based on second configuration information associated with a second network entity controlling the second cell or associated with the second cell.

According to a tenth example of the present disclosure, there is provided the method of the ninth example, wherein one of: the method further comprises, before performing cell reselection or before modifying the forwarding function, receiving the second configuration information from the first network entity or from the second network entity; the method further comprises, after selecting the second cell during the cell reselection, identifying the second configuration information among stored configuration information at the repeater node, the second configuration information being stored, by the repeater node, before camping on the first cell; the method further comprises performing cell reselection only with one or more network entities, including the second network entity, for which configuration information, including the second configuration information, has been obtained prior to performing cell reselection; or the method further comprises receiving an indication of one or more network entities, including the second network entity, associated with the second configuration information, and performing cell reselection with the one or more network entities, wherein the second configuration information is the same as the first configuration information.

According to an eleventh example of the present disclosure, there is provided the method of the any one of the first example to the tenth example, wherein the first cell is selected as the second cell.

According to a twelfth example of the present disclosure, there is provided a method, of a repeater node configured to perform a forwarding function in a network, the method comprising:
camping on a cell in the network; and whilst the forwarding function is on: configuring to turn off cell reselection whilst keeping the forwarding function on; or performing cell reselection based on modified cell reselection parameters in response to detecting a trigger for performing cell reselection.

According to a thirteenth example of the present disclosure, there is provided the method of the twelfth example, wherein the modified cell reselection parameters are received in system information, or in a radio resource control, RRC, message.

According to a fourteenth example of the present disclosure, there is provided the method of the twelfth or thirteenth example, wherein the modified cell reselection parameters are to be met for a configured period of time.

According to a fifteenth example of the present disclosure, there is provided the method of any of the twelfth example to the fourteenth example, wherein the modified cell reselection parameters are at least one of: Qrxlevmin; Qrlevminoffset; Pcompensation; QoffsetTemp; Qqualmin; Qqualminoffset.

According to a sixteenth example of the present disclosure, there is provided the method of the twelfth or thirteenth example, wherein performing cell reselection based on the modified cell reselection parameters comprises: when performing cell reselection, disregarding one or more cells or network entities not associated with first configuration information, wherein the first configuration information is associated with a first network entity controlling the cell and the one or more network entities are indicated in information received from the first network entity; or when performing cell reselection, disregarding one or more cells or network entities for which second configuration information, for use in performing the forwarding function, has not been obtained prior to performing cell reselection.

According to a seventeenth example of the present disclosure, there is provided the method of the twelfth example, wherein cell reselection is turned off for a configured period of time.

According to an eighteenth example of the present disclosure, there is provided the method of the seventeenth example, the configured period of time being one of: a signalled or pre-configured time duration following turning on of the forwarding function; a period of time until the forwarding function changes to off; and until a cell selection criterion is met.

According to a nineteenth example of the present disclosure, there is provided a method, of a repeater node for reporting presence, the method comprising: when camping on a first cell of a network, detecting a trigger for performing cell reselection; performing cell reselection to select a second cell to camp on; camping on the selected second cell; and transmitting a message reporting presence of the repeater node on the selected second cell to a network entity controlling the selected second cell.

According to a twentieth example of the present disclosure, there is provided the method of the nineteenth example, wherein transmitting the message comprises: reporting presence of the repeater node periodically to the controlling network entity; and/or reporting presence based on receiving a signal from another entity.

According to a twenty-first example of the present disclosure, there is provided the method of the nineteenth or twentieth example, wherein reporting presence of the repeater node is performed using RRC signalling.

According to a twenty-second example of the present disclosure, there is provided the method of any of the nineteenth to twenty-first example, wherein reporting presence of the repeater node on the selected cell to the network entity triggers the network entity to notify another network entity controlling the first cell of the presence of the repeater node.

According to a twenty-third example of the present disclosure, there is provided a method of a repeater node for reporting presence, comprising: when camping on a first cell of a network, detecting a trigger for performing cell reselection; performing cell reselection to select a second cell to camp on; camping on the selected second cell; determining the repeater node to be in a new location area different to a location area of the first cell; and transmitting a message reporting presence of the repeater node in the new location area to a network entity.

According to a twenty-fourth example of the present disclosure, there is provided the method of the twenty-third example, wherein the location area is one of a tracking area or a notification area.

According to a twenty-fifth example of the present disclosure, there is provided the method of the twenty-third or twenty-fourth example, further comprising: transmitting a message reporting presence of the repeater node on the selected second cell to a network entity controlling the selected second cell.

According to a twenty-sixth example of the present disclosure, there is provided the method of any of the twenty-third example to the twenty-fifth example, wherein performing cell reselection comprises: for any acceptable cell(s) found by the repeater node, not considering the acceptable cell(s) for cell reselection.

According to a twenty-seventh example of the present disclosure, there is provided a method of a repeater node for configuring measurement relaxation, comprising, while the repeater node is operating in an idle or inactive mode in which measurement relaxation is instructed by a network entity, one of: performing measurement relating to cell reselection by the repeater node without applying measurement relaxation; or determining whether a forwarding function of the repeater node is on, and performing measurement relating to cell reselection by the repeater node based on the determination.

According to a twenty-eighth example of the present disclosure, there is provided the method of the twenty-seventh example, wherein performing measurement based on the determination further comprises: if the forwarding function of the repeater node is off, performing measurement relating to cell reselection without configuring measurement relaxation parameters; or if the forwarding function of the repeater node is on, performing measurement relating to cell reselection by configuring measurement relaxation parameters.

According to a twenty-ninth example of the present disclosure, there is provided a method of a network entity controlling a first cell in a network, comprising: receiving notification of a repeater node camping on the first cell; in response to the notification, notifying another network entity of the presence of the repeater node on the first cell, the other network entity controlling a second cell on which the repeater node camped prior to the first cell.

According to a thirtieth example of the present disclosure, there is provided an apparatus configured to perform the method of any example among the first example to twenty-ninth example.

According to a thirty-first example of the present disclosure, there is provided a computer program comprising instructions which, when the program is executed by a computer or processor, cause the computer or processor to carry out the method of any example among the first example to the twenty-ninth examples.

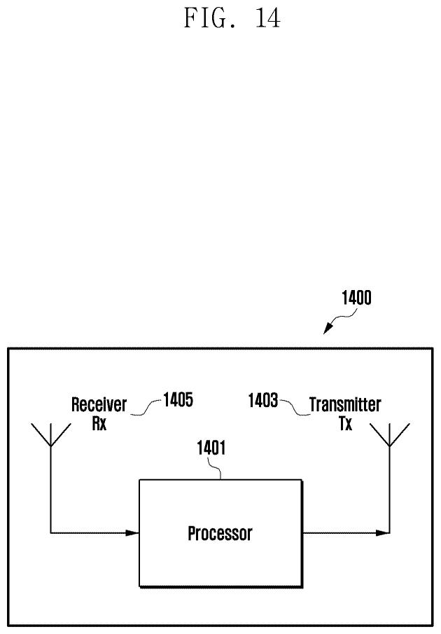

FIG. 14 is a block diagram of an exemplary apparatus, or network entity, that may be used in examples of the present disclosure. The skilled person will appreciate said entity may be implemented, for example, as a network element on a dedicated hardware, as a software instance running on a dedicated hardware, and/or as a virtualised function instantiated on an appropriate platform, e.g. on a cloud infrastructure.

The entity 1400 comprises a processor (or controller) 1401, a transmitter 1403 and a receiver 1405. The receiver 1405 is configured for receiving one or more messages from one or more other network entities, for example as described above. The transmitter 1403 is configured for transmitting one or more messages to one or more other network entities, for example as described above. The processor 1401 is configured for performing one or more operations, for example according to the operations as described above.

The techniques described herein may be implemented using any suitably configured apparatus and/or system. Such an apparatus and/or system may be configured to perform a method according to any aspect, embodiment, example or claim disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment, aspect and/or claim disclosed herein, and/or a machine-readable storage storing such a program. Still further, such programs may be conveyed electronically via any medium, for example a communication signal carried over a wired or wireless connection.

While the invention has been shown and described with reference to certain examples, it will be understood by those skilled in the art that various changes in form and detail may be made therein without departing from the scope of the invention, as defined by the appended claims.

### ABBREVIATIONS/DEFINITIONS

3GPP 3^{rd} Generation Partnership Project
5G 5^{th} Generation
5GC 5G Core
5QI 5G QoS Identifier
5GS 5G System
5GSM 5G System Session Management
5GMM 5G System Mobility Management
AF Application Function
AI Artificial Intelligence
AM Acknowledged Mode
AMF Access and Mobility Management Function
AS Application Server
ASP Application Service Provider
AUSF Authentication Server Function
CDN Content Delivery Network
DCAF Data Collection Application Function
DNAI Data Network Access Identifier
DNN Data Network Name
DNS Domain Name Server
DRB Data Radio Bearer
eNB Evolved Node B
EPC Evolved Packet Core
FEC Forward Error Correction
Fwd Forward
FQDN Fully Qualified Domain Name
GBR Guaranteed Bit Rate
gNB Next generation Node B
GPSI Generic Public Subscription Identifier
HSS Home Subscriber Service
IAB Integrated Access and Backhaul
ID Identity/Identifier
IIOT Industrial Internet of Things
IMEI International Mobile Equipment Identities
IP Internet Protocol
I-SMF Intermediate SMF
LADN Local Area Data Network
LL SSM Lower Layer SSM
LTE Long Term Evolution
MBMS Multimedia Broadcast/Multicast Service
MBS Multicast/Broadcast Service
MBSF Multicast/Broadcast Service Function
MBSTF Multicast/Broadcast Service Transport Function
MB-SMF Multicast/Broadcast Session Management Function
MB-UPF Multicast/Broadcast User Plane Function
ML Machine Learning
MME Mobility Management Entity
MN Master Node
MNO Mobile Network Operator
Msg Message
MT Mobile Termination
NAS Non-Access Stratum
NCR Network-Controlled Repeater
NetCR Network-Controlled Repeater
NEF Network Exposure Function
NRF Network Repository Function
NG-RAN Next Generation Radio Access Network
NG-eNB Next Generation eNB
NSA Non-Standalone
NSSF Network Slice Selection Function
NTN Non-Terrestrial Networks
NUL Normal Uplink
NW Network
NWDAF Network Data Analytics Function
OS Operating System
OSAPP OS Application
PCF Policy Control Function
PCO Protocol Configuration Options
PDR Packet Detection Rule
PDU Protocol Data Unit
PMN Public Land Mobile Network
PTM Point To Multipoint
PTP Point to Point
QFI QoS Flow Identifier (ID)
QoS Quality of Service
RACH Random Access Channel
RAN Radio Access Network
RF Radio Frequency
RNA RAN Notification Area
RRC Radio Resource Control
RRM Radio Resource Management
RSD Route Selection Descriptor
RSRP Reference Signal Received Power
SA Standalone
SDAP Service Data Adaptation Protocol
SDU Service Data Unit
SGW Serving Gateway
SI System Information
SIM Subscriber Identity Module
SLA Service Level Agreement
SM Session Management
SMF Session Management Function
SN Secondary Node
SNPN Stand Alone Non-Public Network
S-NSSAI Single Network Slice Selection Assistance Information
SSB Synchronization Signal Block
SSM Source Specific IP Multicast address
SSC Session and Service Continuity
SRB Signaling Radio Bearer
SUPI Subscription Permanent Identifier
TA Tracking Area
TAG Timing Advance Group
TAI Tracking Area Identity
TE Terminal Equipment
TM Transparent Mode
TMGI Temporary Mobile Group Identity
TS Technical Specification
UDM Unified Data Manager
UDR Unified Data Repository
UE User Equipment
UL Uplink
UM Unacknowledged Mode
UP User Plane
UPF User Plane Function
URLLC Ultra-Reliable and Low-Latency Communication
URSP UE Route Selection Policy

1. A method performed by a network controlled repeater (NCR)-mobile termination (MT) in a wireless communication system, the method comprising:
performing a state transition from a radio resource control (RRC) connected state to a RRC inactivate state;
performing a cell reselection in the RRC inactive state; and
in case that no suitable cell is detected or a cell other than a last serving cell is selected, transferring, to a NCR-forward (FWD), an indication to cease a forwarding.

2. The method of claim 1, further comprising:
receiving, from a base station, side control information associated with the forwarding of the NCR-FWD.

3. The method of claim 2,
wherein an amplifying-and-forwarding of a signal is continued in the NCR-FWD based on the side control information, in case that the NCR-MT is transitioned from the RRC connected state to the RRC inactive state.

4. The method of claim 1, wherein the performing the cell reselection further comprises:
performing a measurement for the last serving cell and at least one neighbouring cell; and
in case that a cell reselection criteria is met based on the measurement, selecting the cell other than the last serving cell.

5. The method of claim 4, wherein, in case that the cell reselection criteria is not met, it is identified that the no suitable cell is detected.

6. The method of claim 1,
wherein the NCR-MT is an entity for receiving side control information, and
wherein the NCR-FWD is an entity for performing an amplifying-and-forwarding of a signal between a base station and a terminal.

7. A network controlled repeater (NCR)-mobile termination (MT) in a wireless communication system, the NCR-MT comprising:
a transceiver; and
a controller coupled with the transceiver and configured to:
perform a state transition from a radio resource control (RRC) connected state to a RRC inactivate state,
perform a cell reselection in the RRC inactive state, and
in case that no suitable cell is detected or a cell other than a last serving cell is selected, transfer, to a NCR-forward (FWD), an indication to cease a forwarding.

8. The NCR-MT of claim 7, wherein the controller is further configured to:
receive, from a base station, side control information associated with the forwarding of the NCR-FWD.

9. The NCR-MT of claim 8,
wherein a amplifying-and-forwarding of a signal is continued in the NCR-FWD based on the side control information, in case that the NCR-MT is transitioned from the RRC connected state to the RRC inactive state.

10. The NCR-MT of claim 7,
wherein the controller is further configured to:
perform a measurement for the last serving cell and at least one neighbouring cell, and
in case that a cell reselection criteria is met based on the measurement, select the cell other than the last serving cell.

11. The NCR-MT of claim 10, wherein, in case that the cell reselection criteria is not met, it is identified that the no suitable cell is detected.

12. The NCR-MT of claim 7,
wherein the NCR-MT is an entity for receiving side control information, and
wherein the NCR-FWD is an entity for performing an amplifying-and-forwarding of a signal between a base station and a terminal.
